(19) United States
(12) Patent Application Publication
(10) Pub. No.: US 2024/0372648 A1
(43) Pub. Date: Nov. 7, 2024

(54) METHOD FOR OPTIMAL AND SCALABLE QUADRATURE SPACE-TIME MODULATION

(71) Applicant: Continental Automotive Technologies GmbH, Hannover (DE)

(72) Inventors: David Gonzalez Gonzalez, Egelsbach (DE); Osvaldo Gonsa, Frankfurt (DE); Hiroki Iimori, Yokahama (JP); Giuseppe Thadeu Freitas de Abreu, Bremen (DE); Hyeon Seok Rou, Bremen (DE)

(73) Assignee: Continental Automotive Technologies GmbH, Hannover (DE)

(21) Appl. No.: 18/291,236

(22) PCT Filed: Jul. 25, 2022
(86) PCT No.: PCT/EP2022/070798

§ 371 Date: Jan. 23, 2024

(30) Foreign Application Priority Data
Jul. 23, 2021 (DE) 10 2021 207 915.6

(51) Int. Cl. H04L 1/06; H04L 5/00

(52) U.S. Cl. CPC H04L 1/0612; H04L 1/0668; H04L 5/0003

(57) ABSTRACT

Scalable space-time quadrature spatial modulation for multidimensional wireless systems is performed by configuring a plurality of transmit antennas to each represent an in-phase spatial constellation symbol within an in-phase spatial constellation, and a quadrature spatial constellation symbol within a quadrature spatial constellation, mapping source data to the in-phase spatial constellation symbols and the quadrature spatial constellation symbols represented by the plurality of transmit antennas, wherein the method constructs the set which has equal multiplicities of the transmit antenna activation, which ensures maximum possible transmit diversity and reduces the required complexity, making this feasible for larger number of antennas.

### TECHNICAL FIELD

The present invention relates to the field of decoding digital communications in overloaded channels.

### BACKGROUND

In advanced spatial modulation (SM) schemes, only a fraction of transmit antennas are activated per symbol slot, via dispersion matrices which determine the activation patterns. This selection is determined by so-called index vectors which hold integer values corresponding to the index of the dispersion matrix to be simultaneously activated. The construction of the set index vectors is done naïvely in combinatorial order up to the state-of-the-art (SotA), however this leads to unequal allocations for the transmit antennas and hence a degradation in transmit diversity

Spatial modulation (SM) technique is a well-known technique for MIMO systems for which the present invention introduces a novel method to transmit additional information bits via transmit antenna selection (spatial dimension) on top of the traditional information bits via symbol selection (constellation dimension). From the traditional SM which selected only one antenna which restricted the total antenna number to a power of two, the generalized SM was developed to allow any number of total antennas by selecting a combination of multiple antennas out of the available transmit antennas.

Then transmit diversity is introduced to SM by combining the notion of space-time code (STC) with SM-MIMO, adding the temporal dimension by allowing multiple symbol periods within the code design. Significant works include the space-time shift keying (STSK) schemes based on a linear dispersion (LD) code by Sugiura et al, and space-time block coding (STBC) based schemes such as STBC-SM and STBC-CSM.

In parallel, a contrasting technique to improve the transmit diversity is introduced through the quadrature spatial modulation (QSM) scheme, where the traditional SM idea is applied separately in each of the real and complex components of the transmit signal.

The idea is supplemented with increased transmit diversity in diversity-achieving quadrature spatial modulation (DA-QSM). Finally, very recently, incorporating the STBC-SM idea to the DA-QSM, an Enhanced Diversity-Achieving Quadrature Spatial Modulation (EDA-QSM), which is shown to outperform all its predecessors

The SotA EDA-QSM scheme has the following limitations:
Sub-optimal coding gain,
Maximum allowed symbol periods restricted to two,
Transmit antennas restricted to even numbers.
Sub-optimal spectral efficiency

Through this approach, the vast stationary sources associated with massive MIMO systems can be efficiently utilized the fault requiring an equally large number of radiofrequency (RF) chain components. This efficient utilization of RF-chains makes SM schemes attractive for future wireless systems such as beyond fifth generation (B5G), which will continue to make extensive use of millimeter-wave (mmWave) bands, and sixth generation (6G) networks [6], which are expected to also incorporate Terahertz and visible light communications (VLC) bands.

A major drawback of early SM schemes is, however, that only one antenna is selected per transmission, which severely limits achievable SEs. In order to circumvent this limitation, a generalized spatial modulation (GSM) scheme was later developed, where multiple antennas are selected at each transmission, leading to substantial increase in SE. But another drawback of early SM methods including GSM schemes, was the exclusive focus on increasing SE without a matching effort to reduce BER, e.g., via the exploitation of transmit diversity. That limitation motivated the idea of combining SM with space-time coding (STC), examples of which are the space-time shift keying (STSK) schemes based on linear dispersion (LD) coding, the methods incorporating space-time block coding (STBC) and the spatial modulation with cyclic structure (CSM).

Based on this knowledge then it was proceeded for further optimize the SM transmitter design, leading to the discovery of quadrature spatial modulation (QSM) approaches in which the SM concept is independently applied to each of the real and imaginary components of the modulated signals, via dedicated spatial-temporal dispersion matrices. The idea was further developed in a succession of QSM techniques with progressively enhanced dispersion matrix designs, which include the diversity-achieving quadrature spatial modulation (DA-QSM) scheme by the incorporation of Alamouti codes, and the more recent enhanced diversity-achieving quadrature spatial modulation (EDA-QSM) method in which dispersion matrices are constructed using the full-diversity full-rate (FDFR) codes with block-by-block sphere-decodability of [24]. Among all aforementioned schemes, the EDA-QSM is the best QSM scheme known today, both in terms of BER and SE performance.

Despite these advantages, the EDA-QSM scheme, and as a consequence preceding QSM schemes, still have two major shortcomings. The first is that the dispersion matrices used in QSM schemes proposed so far are based on 2×2 STBCs, which limits both the diversity and coding gains achieved by the methods. With regards to that first limitation, we will in fact show in this article that QSM designs based on STBCs of a size T that does not scale with n_{T} are fundamentally sub-optimal in the SE sense. The second shortcoming is that current QSM detection schemes are based either on exhaustive maximum likelihood (ML) or, at best, sphere detectors. Here, it is worth noting that it has actually been, contrary to previous claims, that sphere decoding has an average complexity that still grows exponentially with the number of jointly decoded symbol periods. That result was corroborated by some findings, where a cubic closed-form expression for the expected complexity of sphere detectors was derived, as well as, where it was shown that lattice-reduction does not improve the tail exponent of the complexity distribution of sphere detectors. With regards to that second limitation, it will be shown in this application that in fact the complexity of ML- and sphere detection (SD)-based QSM receivers are both geometric on n_{T} and T, with P as exponent, such that these techniques are fundamentally non-scalable in the context of QSM systems. In other words, a severe and two-folded scalability challenge exists among current QSM schemes, namely, the absence of scalable transmitter and receiver designs.

Motivated by this challenge, in this application a new QSM solution that is both, at the transmitter side, scalable to arbitrary block sizes i.e., with no limits on n_{T}, T and P, and, at the receiver side, decodable in polynomial time i.e., practical for large n_{T} and T, with moderate P is contributed. As a bonus, which can be seen is that the proposed QSM scheme with every possibility to optimize SE, diversity and coding gains. To that end, we first introduce the optimal FDFR Golden STBC code of in the design of the QSM dispersion matrices. The Golden code is a fast-decodable STBC known to be optimal i.e., FDFR with highest coding gain over Gaussian constellations, and which was shown in to be constructible generally for arbitrary block sizes. The resulting optimized scalable QSM (OS-QSM) scheme is the first method proposed so far which has this feature.

The new OS-QSM design is further enhanced with a new algorithm to select the indices of the dispersion matrices employed in the scheme, which ensures that all transmit antennas are utilized as often and with the same likelihood over the transmission of multiple blocks, thus ensuring optimally diverse utilization of all spatial-temporal resources. Finally, in order to also ensure feasible decodability to the scalable transmitter design, a new greedy boxed iterative shrinkage thresholding algorithm (GB-ISTA) QSM detector based on sparse recovery methods is proposed.

Thanks to its sparse signal processing approach, the proposed decoding scheme does not require any restriction on the core code design, unlike preceding sphere-detection methods which requires block-diagonal fast-decodability. But in addition and most importantly, a major advantage of the new proposed GB-ISTA QSM receiver is that it does not require a search over the large codebook space, unlike the ML and state codewords matched block-by-block sphere decoding (SCMB-SD). In fact, the complexity order of the proposed receiver is shown to be cubic on T, quadratic on P, and only linear on n_{T}.

All in all, the contributions of the article can be summarized as follows: Spectral Efficiency-Optimality: A closed form expression for the optimum number of encoded symbols P required for a QSM to achieve SE optimality are given, which combined to the rate-optimality condition of STBCs, highlights the importance of systematic scalability of the STBC size T in the design of SE-optimal QSM schemes.
Optimal Diversity and Coding Gains: A new Golden code-based quadrature spatial modulation (GQSM) transmission scheme is obtained via the design of dispersion matrices based on the 2×2 Golden code, which is known to achieve optimal coding gain over integer symbol constellations·Scalability of Transmitter: the new GQSM design is generalized via the extension of the 2×2 Golden code into its T×T FDFR STBC variation, yielding the OS-QSM scheme, which is applicable to arbitrary nT, T and P.
Optimality of Resource Utilization: In method 1, a new mechanism to select the optimal set of dispersion matrix indices is offered, which ensures that all Q spatial-temporal resources are equally utilized over time, as required for optimal diversity gain.
Scalability at Receiver: A new low-complexity greedy iterative shrinkage thresholding algorithm (ISTA)-based demodulation algorithm for GSM schemes is proposed, which not only is feasible at large scales due to its linear complexity, but also can be applied to other STBC-QSM schemes.
Complexity of Receiver: A novel complexity expression of the proposed receiver is derived and shown to be cubic on T, quadratic on P, and linear on n_{T}, in contrast to the ML and SD receivers which are geometric on T and nT, with Pas exponent.

In future wireless communication systems of beyond-fifth generation (B5G) and sixth generation (6G), one of the main expectations is that in the multiple-input multiple-output (MIMO) set-up, the number of transmit and receive antennas will be increased greatly to support the requirements.

The main issue or challenge with existing solutions arises when the system scales to the relevant large MIMO, which by the nature of the tree-searching algorithms, can make the SCMB-SD scheme impractical.

In other words, when the number of antennas increases, i.e., larger MIMO systems, spatial modulation becomes problematic/unfeasible.

The proposed (Greedy ISTA decoding) method is designed to decode the (Golden) Enhanced Diversity-Achieving Quadrature Spatial Modulation (EDAQSM) signal for higher order MIMO systems with an affordable complexity.

As indicating, spatial modulation is in practice not feasible when the number of antennas increases, i.e., larger MIMO systems. Therefore, all its benefits are not attainable in practice. The propose method reduces significantly the required complexity, making this feasible in practice for larger number of antennas (16×16 systems).

This invention has a significant impact for mmW-based communications, which is a direction of the growth field Advanced Connectivity Technologies.
1) Multiaccess transmitter design: in particular, thanks to the generalization of the Golden code now introduced, in combination with spatial modulation, it is possible to operate with a highly sparse received signal. This allows for the overlapping of multiple users without causing large multi-user interference.
2) Multidimensional modulation: although the design is currently in space and time “only”, the intention is to extend it to include also the frequency domain. The result would be a “tensor-based” modulation in frequency, space, and time. The extra dimension, with a similar architecture we have developed so far, should tend to only make the signals per-user more-sparse, again allowing for even more users to be overlapped without increasing effective multi-user interference.
3) Builds a connection with Coding (a transmitter side aspect). Coding has been an aspect on which we have not fully focused on so far in the context of this project. Major contributions have been made on detection performance and robustness (against practical issues) for overloaded systems. This work will enable us to jointly address detection and decoding (joint optimization).

The previous, in more simple terms, will enable communication systems with more capacity, more users per bandwidth unit to allow hyper-dense communication scenarios.

These and other objects, features and advantages of the present invention will become clearer when the drawings as well as the detailed description are taken into consideration.

These and other objects, features and advantages of the present invention will become clearer when the drawings as well as the detailed description are taken into consideration.

This problem was not addressed in any previous spatial modulation schemes leading up to the enhanced diversity-achieving quadrature spatial modulation (EDA-QSM), which is the SotA and no previous solution found.

In order to address the aforementioned problem and to remove the limitations of the SotA scheme (EDA-QSM), an optimal and scalable quadrature spatial modulation scheme (OS-QSM) is proposed. Specifically, the design regards the highlighted section of the QSM signal generation flowchart.

The OS-QSM leverages the full-diversity full-rate (FDFR) Golden STC and its generalization to FDFR Perfect STC, which achieves optimal coding gains upto T=6. By using these STCs in replacement of the Sezginer-Sari-Biglier (SSB) STBC utilized in the EDA-QSM, and applying necessary power adjustments and extensions to construct the final dispersion matrices of the QSM.

Specifically, in the dotted highlighted section of the QSM signal generation flowchart/block diagram in FIG. 1 represent the solution of the cited problem.

The OS-QSM can be equally used for any systems and situations in replacement of previous SM schemes. Systems which is only able to support a fraction of RF-chains than the number of antennas would specifically benefit, as the nature of SM. Cellular network and V2X communications can be performed with better efficiency and data rate (eMBB).

Complex matrices and vectors are denoted in bold-face uppercase and lowercase letters, with their elements denoted by indexed normal lowercase letters, as in X, x and xᵢ, respectively. The real and the imaginary parts of a complex number x are respectively denoted by x^{R} and x^{I}, respectively, and for the sake of future convenience we define for a complex vector x=[x₁, x₂, . . . , xₙ]^{T} the associated decoupled vector x≙[x₁^{R}, x₁^{I}, . . . , xₙ^{R}, xₙ^{I}]T and corresponding quadrature representation

$$\\ \check{x} {=}^{△} [ \begin{matrix}{x}^{{}_{} R} & - {x}^{{}_{} I} \\ {x}^{{}_{} I} & {x}^{{}_{} R}\end{matrix} ] .$$

The quadrature operator (·) will also be applied to m×n complex matrices X, for which it yields the corresponding 2m×2n matrix,

$$\\ \check{X} {=}^{△} [ \begin{matrix}{\check{x}}_{1 , 1} & ⋯ & {\check{x}}_{1 , n} \\ ⋮ & ⋱ & ⋮ \\ {\check{x}}_{m , 1} & ⋯ & {\check{x}}_{m , n}\end{matrix} ] .$$

In turn, the complex conjugate, transpose, Hermitian, trace, vectorization, and the diagonalization operators are denoted by (·)*, (·)^{T}, (·)^{H}, tr(·), ver (·), and dias (·) respectively, while the n x n identity and the m×n-sized all-zero and all-one matrices are respectively denoted by Iₙ, O_{m×n}, and 1_{m×n}. The p-norm p≥0 is denoted ∥·∥ₗ, while |·| denotes either element-wise absolute value operation (for vectors) or cardinality (for sets), respectively, and the sets of real, complex, and integer numbers are denoted by [symbol] , [symbol] , and [symbol] , respectively. Expectation is denoted as [symbol] [·]. the floor to the nearest power of 2 is represented by [·]₂, the conversion operation of a left-most-significant binary vector to the corresponding base-10 integer is denoted by [·]₍₁₀₎. The binomial coefficient is denoted by (_{P}^{Q}), and ⊗ denotes the Kronecker product. The projection of a scalar v onto the set χ is denoted by [symbol] _{χ}(ν) the complex Gaussian distribution with mean u and variance σ² is denoted by ˜ [symbol] (μ, σ²).

All the previous State of the Art spatial modulation (SM) schemes use ML such as in most spatial modulation (SM) or modified tree-search algorithms such as in the state of the art SM scheme of EDA-QSM to decode SM signals and no notable attempts on sparse detection or greedy approaches.

The tree-search algorithm is extremely unrealistic due to the highly combinatoric nature of the SM and the resulting search space size. Furthermore, the SM imposes various restrictions on the structure of the decoded signal such that naïve low-complexity decoding is impossible.

The problem associated with prior art is that there is no sparse detection solution for the problem. Solutions using other approaches features prohibitive complexity.

Massive multiple-input multiple-output (MIMO) systems in beyond-fifth generation (B5G) and sixth generation (6G) wireless communications expect incorporation of many transmit and receive antennas.

Utilization of Spatial Modulation (SM) and its variants such as quadrature spatial modulation (QSM) is one promising candidate for massive MIMO systems. However, as the system size grows, the classic decoding complexity of the SM schemes becomes infeasible (i.e., complexity is not affordable) as the SotA uses maximum likelihood (ML) decoding or ML based tree-search algorithms.

The method constructs the set which has equal multiplicities of the transmit antenna activation, which ensures maximum possible transmit diversity, like it is shown in FIG. 5. In the previous SotA, this was not the case as there was no equal multiplicity and hence non-optimal transmit diversity was exploited from the number of available antennas, i.e., all the antennas are used by the same amount).

All existing spatial modulations schemes benefit, as all spatial modulation schemes already utilize index vector selection (or can be reformulated such). The scheme can be used to increase data rate and increase efficiency in cellular networks and V2X communications (eMBB).

These and other objects, features and advantages of the present invention will become clearer when the drawings as well as the detailed description are taken into consideration.

The proposed decoder possesses significantly low complexity compared to the existing ML and tree-search algorithms. The decoder possesses a quadratic complexity on the number of transmit antennas.

Furthermore, the proposed decoder also does not require design restrictions such as block-diagonality or orthogonality in the transmission scheme, only the sparsity which is inherent with spatial modulation schemes, therefore providing larger freedom in transmitter development as well. In other words, the proposed decoder is capable of coping with many different encoding structures (flexibility).

The decoder can be used in any MIMO system where the number of antennas is expected to be large, such that ML approaches are infeasible. The scheme can be used to increase efficiency in cellular networks and V2X communications (eMBB).

These and other objects, features and advantages of the present invention will become clearer when the drawings as well as the detailed description are taken into consideration.

One embodiments of Optimal and Scalable Quadrature Space-Time Modulation (OS-QSM) method configuring a plurality of transmit antennas configuring a plurality of transmit antennas to each represent an in-phase spatial constellation symbol within an in-phase spatial constellation, and a quadrature spatial constellation symbol within a quadrature spatial constellation, mapping source data to the in-phase spatial constellation symbols and the quadrature spatial constellation symbols represented by the plurality of transmit antennas, wherein the method is applying an optimal and scalable quadrature spatial modulation scheme (OS-QSM) resulting in a maximum possible coding gain in the resultant quadrature spatial modulation.

Another embodiment of the computer-implemented decoding method is characterized by a modification to the iterative shrinkage-thresholding algorithm (ISTA) via boxing, range limiting and hard-thresholding.

Another embodiment of the computer-implemented decoding method is characterized by proceeding the iterative shrinkage-thresholding algorithm via boxing-hard (ISTA), a greedy selection of the positions of the antennas index and the symbol estimates, and their independent decoding of the corresponding antenna modulated and symbol modulated bits.

Another embodiment of the computer-implemented decoding method is characterized by, wherein process working parallel to the greedy detections, to ensure valid estimates of the index vectors from the given finite set of index vectors are produced as an output and to apply interference cancellation with the confirmed values.
while keeping track of which indices have been retrieved from the greedy selections, before every iteration check whether from the currently decoded indices, a final confirmation can be made.
If it cannot be made, remove the interference by the previous greedy selection and make the next iteration

Another embodiment is characterized by the generalization of the Golden code and in combination with spatial modulation an operating calculation with a highly sparse received signal is done, without causing large multi-user interference for the overlapping of multiple users.

Another embodiment is characterized by making the signals per-user more-sparse, again allowing for even more users to be overlapped without increasing effective multi-user interference.

Another embodiment is characterized by a receiver (R) of a communication system having a processor, volatile and/or non-volatile memory, at least one interface adapted to receive a signal in a communication channel, wherein the non-volatile memory stores computer program instructions which, when executed by the microprocessor, configure the receiver to implement the decoding method of one or more embodiments cited above.

Another embodiment is characterized by a receiver by computer program product comprising computer executable instructions, which, when executed on a computer, cause the computer to perform the decoding method of one or more embodiments cited above.

Another embodiment is characterized by a computer-readable medium storing and/or transmitting the computer program product cited above.

Another embodiment is characterized by vehicle unit comprising a communication system with a receiver (R) in a vehicle wherein the system is adapted to execute the method according to one or more the decoding method of one or more embodiments cited above.

Another embodiment is characterized by a vehicle having one or more vehicle units cited above.

All aspects in this application can be integrated in a mobile devices, base station and components in wireless systems. All the describes components can be integrated in vehicles.

### BRIEF DESCRIPTION OF THE DRAWINGS

For a fuller understanding of the nature of the present invention, reference should be had to the following detailed description taken in connection with the accompanying drawings in which:

Quadrature spatial modulation (QSM) schemes are considered, which are capable of conveying large numbers of bits while a combination of transmitting a relatively small number P all M-ary modulated symbols from a dynamic selection of n transmit into mass, according to a designed dispersion pattern.

FIG. 1: is Schematic diagram depicting the generic structure of a QSM transmission scheme.

FIG. 2: is the Spectral efficiency of OS-QSM scheme with T=2, 4, and 8, for a given system with n_{T}=8 and M=4

FIG. 3: is the Effect of T and M on the optimum ratio P*/T between the number of transmit symbols and epochs

FIG. 4: is the Behavior of fractional peak spectral efficiency as a function of n_{T}, for different sizes of T and M.

FIG. 5 is the bipartite graph representing the spatial-temporal resource usage associated with each index vector kₙ for a QSM system with P=3 and Q=8. The particular examples of k₁, k₃₇ and k₅₄ are explicitly illustrated

FIG. 6 is the Comparison of ISTA thresholding and BH-ISTA thresholding functions Λ(s; T)], and Π(s; T), as per equation (29)

FIG. 7: is the Convergence of u\hat{ }n⁽ⁿ⁾ and u\hat{ }Λ⁽ⁿ⁾, as per equations (28) and (30), respectively, as a function of iterations n
FIG. 7 (a) is the Sparsity convergence with various threshold values
FIG. 7 (b) is the MSE convergence with optimal threshold values

FIG. 8 is the Schematic diagram depicting the structure of the proposed GB-ISTA receiver for QSM demodulation

FIG. 9 is the Effect of scalable parameters on the complexity of QSM receivers.
FIG. 9 (a) is the Fixed P, various T, as a function of n_{T}
FIG. 9 (b) is the Fixed T, various P, as a function of n_{T}
FIG. 9 (c) is the Fixed n_{T}, various T, as a function of P.

FIG. 10: is the Effect of scalability on BER performance ofGB-ISTA-detected OS-QSM schemes with fixed SE.

FIG. 11: is the Effect of scaling P on BER performance of GB-ISTA-detected OS-QSM schemes.

FIG. 12 is a Comparisons of previous spatial modulation schemes

FIG. 13 is Comparison of Golden EDA-QSM and Original EDA-QSM with ML Decodin

FIG. 14 is Golden EDA-QSM vs Original EDA-QSM with Theoretical ABEP

FIG. 15 is the Effect of n_{T} on spectral efficiency of the EDA-QSM FIG. 16 is the Effect of n_{T} of P on spectral efficiency of the EDA-QSM

FIG. 17 is is the Effect on spectral efficiency of the EDA-QSM, for GISTA feasible regions

FIG. 18 is Average number of GISTA iterations with GISTA Decoding

FIG. 19 is the Illustrations of decoding complexities between the ML and GISTA decoders

FIG. 20 is Performance comparison between GISTA and Full-ML Decoders (n_{T} 4)

FIG. 21 is Performance comparison of GISTA Decoding

### DETAILED DESCRIPTION

Following are detailed descriptions of concepts, system/network architectures, and detailed designs for many aspects of a wireless communications network targeted to address the requirements and use cases for 5G. The terms “requirement.” “need,” or similar language are to be understood as describing a desirable feature or functionality of the system in the sense of an advantageous design of certain embodiments, and not as indicating a necessary or essential element of all embodiments. As such, in the following each requirement and each capability described as required, important, needed, or described with similar language, is to be understood as optional.

In the discussion that follows, this wireless communications network, which includes wireless devices, radio access networks, and core networks, is referred to as “NX.” It should be understood that the term “NX” is used herein as simply a label, for convenience. Implementations of wireless devices, radio network equipment, network nodes, and networks that include some or all of the features detailed herein may, of course, be referred to by any of various names. In future development of specifications for 5G, for example, the terms “New Radio,” or “NR,” or “NR multi-mode” may be used—it will be understood that some or all of the features described here in the context of NX may be directly applicable to these specifications for NR. Likewise, while the various technologies and features described herein are targeted to a “5G” wireless communications network, specific implementations of wireless devices, radio network equipment, network nodes, and networks that include some or all of the features detailed herein may or may not be referred to by the term “5G.” The present invention relates to all individual aspects of NX, but also to developments in other technologies, such as LTE, in the interaction and interworking with NX. Furthermore, each such individual aspect and each such individual development constitutes a separable embodiment of the invention.

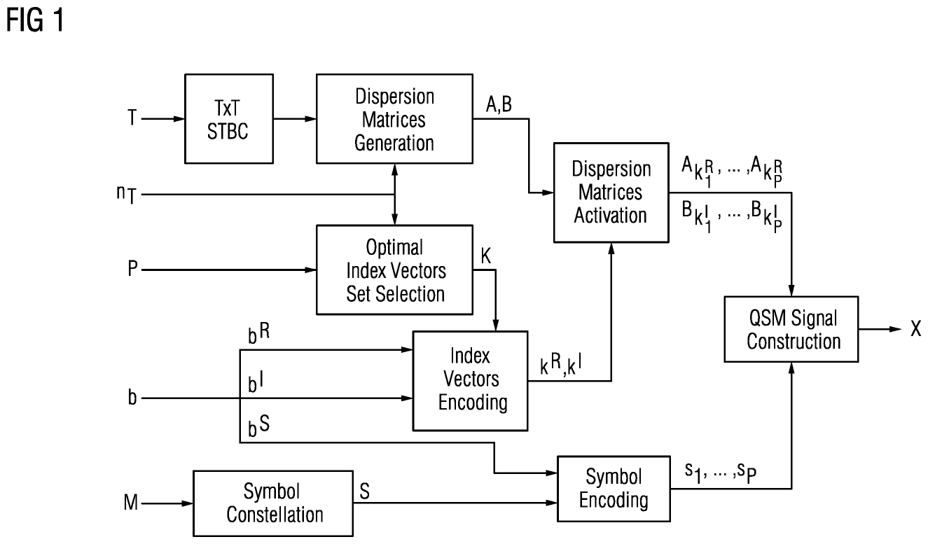

FIG. 1 shows schematic diagram depicting the generic structure of a QSM transmission scheme.

### A. System Model

Consider a point-to-point (P2P) MIMO communication system in which a transmitter equipped with n_{T} transmit antennas exchanges information with a receiver equipped with n_{R} receive antennas employing SM. The received signal corresponding to T consecutive time slots during which the channel is assumed to be constant can be compactly written as

$$\\ \begin{matrix}Y = HX + V ∈ {ℂ}^{{}_{} {n}_{R} \times T} & ( 1 )\end{matrix}$$

Where Y∈ [symbol] ⁿ^{_{R}}^{×T} is the matrix collecting the signals received at each antenna and time slot, H∈ [symbol] ⁿ^{_{R}}^{×n}^{_{T}} is the flat-fading channel matrix with elements hᵢⱼ˜ [symbol] (0, 1), X∈ [symbol] ⁿ^{_{T}}^{×T} is the space-time transmit signal, and V∈ [symbol] ⁿ^{_{R}}^{×T} is the additive white Gaussian noise (AWGN) matrix with elements U_{i,j}˜ [symbol] (0, N₀) where N₀ is the noise variance.

It is assumed hereafter that the quasi-static Rayleigh fading channel matrix H is known at the receiver but not at the transmitter, and it is remarked that since the channel power per matrix entry is unitary, the fundamental signal-to-noise ratio (SNR) is given by

$$\\ ρ {=}^{△} \frac{1}{{N}_{0}} 𝔼 [ tr ( {X}^{{}_{} H} X ) ] .$$

In turn, in accordance with related QSM literature and as illustrated in FIG. 1, the transmit signal matrix X is constructed in a manner to convey the information of a bit sequence b, both in the form of P digitally modulated signals, as well as in the form of the allocation of such transmissions to different antennas and time instances, as described by

$$\\ \begin{matrix}X = {\sum }_{p = 1}^{P} ( {s}_{p}^{{}_{} R} {A}_{{k}_{p}^{{}_{} R}} + {s}_{p}^{{}_{} I} {B}_{{k}_{p}^{{}_{} I}} ) & ( 2 )\end{matrix}$$

where sₚ=sₚ^{R}+jsₚ^{I}, with p={1, . . . , P}, are transmit symbols chosen from a complex constellation constellation S of cardinality |S|=M; A_{K}_{_{P}}_{R} . . . and B_{K}_{_{P}}_{I} are dispersion matrices belonging to the sets [symbol] ={A_{q}}_{q=1}^{Q}∈ [symbol] ⁿ^{_{T}}^{×T} and [symbol] ={B_{q}}_{q=1}^{Q} [symbol] ⁿ^{_{T}}^{×T} with Q≙T×n_{T}; and the indices kₚ^{R} and kₚ^{I} are the path elements of the index vectors k^{R} and k^{I}, respectively, which are selected from an optimized set of index vectors [symbol] ={kₙ}ₙ₌₁^{N} ∈ [symbol] ^{P}, with N≙[(_{P}^{Q})]_{2X}.

With regards to equation (2), and again referring to FIG. 1, it is clarified that in QSM schemes the bit sequence b is subdivided into a sequence b^{s}, of length B^{s}≙Plog₂|S|=Plog₂M, which corresponds to the information encoded in the symbols s={s1, . . . , Sₚ}, taken from S, and the conjugate sequences b^{R} and b^{I}, both of length R^{S}≙Plog₂|S|=Plog₂ M, which correspond to the information encoded in the selection of spatial-temporal resources according to the dispersion matrix index vectors k^{R} and k^{I} from A . . .

In view of the above, it can be said that the design of a specific QSM scheme amounts essentially to the method employed in the construction of each of the Q dispersion matrices A_{q} and B_{q} in the sets A and B, and the selection of the set K containing the index vectors k^{R} and k^{I} which inform the choices of dispersion matrices used in each transmission.

To exemplify how state-of-the-art (SotA) QSM schemes can be cast into the general framework described by equation (2), consider first the QSM scheme. In this case, the dispersion matrices reduce to dispersion vectors (i.e., T=1 and Q=n_{T}) which are given by

$${A}_{q} = {e}_{q} and {B}_{q} = {je}_{q} , \qquad ( 3 )$$

where e_{q} is the q-th column of I_{Q}, and no specific design criteria are given for the selection of the indices in the index vectors k^{R} and k^{I}.

In turn, in the DA-QSM scheme, two-column dispersion matrices (i.e., T=2 and Q=n_{T}) are employed so as to exploit transmit diversity. In particular, in this scheme

$${A}_{q} = {M}_{{n}_{T}}^{q - 1} \tilde{A} and {B}_{q} = {jM}_{{n}_{T}}^{q - 1} \tilde{B} , \text{?} \qquad ( 4 )$$

$$\text{?} \text{indicates text missing or illegible when filed}$$

with

$$\tilde{A} {=}^{△} [ \begin{matrix}{I}_{2} \\ 0 \text{?}\end{matrix} ] and \tilde{B} {=}^{△} [ \begin{matrix}{M}_{2} \\ 0 \text{?}\end{matrix} ] ,$$

$$\text{?} \text{indicates text missing or illegible when filed}$$

where Mₙ is an n×n cyclic lower-shift matrix, Mₙ Is obtained by circularly shifting the bottom row of Iₙ to the top, such that, e.g.,

$${M}_{n \text{?}} = [ \begin{matrix}0 & \text{?} & 1 \\ \text{?} & 0 & 0 \\ 0 & 1 & 0\end{matrix} ] \text{?} ,$$

$$\text{?} \text{indicates text missing or illegible when filed}$$

such that its (q-1)-th power pre-multiplied to a given matrix results in a shift of the bottom (q-1) rows of the latter to the top.

From the above it is visible that the DA-QSM scheme improves over the QSM scheme essentially by adding diversity, i.e., by extending the transmission instances from T=1 to T=2. However, the dispersion matrices of the DA-QSM method are still real, just as those of the QSM scheme, implicating that no additional multiplexing capability is aggregated, and that coding gains is not optimized.

In contrast, the EDA-QSM method improves over the latter on both aspects. In particular, in this scheme the dispersion matrices are more elaborately designed as

$${A}_{q} = {A}_{4 ( ℓ - 1 ) + i} = {e}_{ℓ} ⊗ {C}_{i} and {B}_{q} = {B}_{4 ( ℓ - 1 ) + i} = {e}_{ℓ} ⊗ {D}_{i} \qquad ( 5 )$$

where e_{I} is the I-th column of I_{L}, with L≙n_{T}/2, the indices i∈{1, . . . , 4} and I∈{1, . . , L}, and the core matrices Cᵢ and Dᵢ are based on the Sezginer-Sari-Biglieri (SSB) STBC described by

$${S}_{SSB} = [ \begin{matrix}{s}_{1} + {bs}_{3} & - {s}_{2}^{*} + {jbs}_{4}^{*} \\ {s}_{2} + {bs}_{4} & {s}_{1}^{*} - {jbs}_{3}^{*}\end{matrix} ] = {\sum }_{i = 1}^{4} {s}_{i}^{R} {C}_{i} + {s}_{i}^{I} {D}_{i} \qquad ( 6 )$$

$$b {=}^{△} \frac{( 1 - \sqrt{7} ) + j ( 1 + \sqrt{7} )}{4} , \text{?}$$

$$with {C}_{1} {=}^{△} {I}_{2} , {C}_{2} {=}^{△} Z , {C}_{3} {=}^{△} bW , and {C}_{4} {=}^{△} Z \cdot {C}_{3} , \text{?} \qquad ( 7 a )$$

$${D}_{1} {=}^{△} {jM}_{2} \cdot Z , {D}_{2} {=}^{△} Z \cdot {D}_{1} , {D}_{3} {=}^{△} - {bM}_{2} \cdot W \cdot {M}_{2} , and {D}_{4} {=}^{△} Z \cdot {D}_{3} , \text{?} \qquad ( 7 b )$$

$$where Z {=}^{△} [ \begin{matrix}0 & - 1 \\ 1 & 0\end{matrix} ] and W {=}^{△} [ \begin{matrix}1 & 0 \\ 0 & - j\end{matrix} ]$$

$$\text{?} \text{indicates text missing or illegible when filed}$$

Through the concise description above it becomes easy to see that the fundamental distinction between the DA-QSM and the EDA-QSM methods is that the dispersion matrices of EDA-QSM are complex-valued, such that the orthogonality between the real and imaginary dimensions are better exploited in order to reap multiplexing and coding gains.

Two fair criticisms that can be made of the aforementioned schemes—and in fact, to the best of our knowledge of all existing SotA QSM methods proposed so far—are, however: a) that the scheme does not scale systematically simultaneously over space and time, for arbitrary T>2; and b) that the coding gain achieved is not optimum. Mitigating these two limitations is the objective of our first contribution described in the following section.

### Optimized Scalable Quadrature Spatial Modulation Transmitter Design

### A. Spectral Efficiency Optimality of QSM Schemes

Given the number of bits carried by the transmission of each QSM transmit symbol X as per equation (2), and the fact that such transmission requires T successive channel uses, the SEζ of any QSM scheme is given by

$$ζ ( P , T ; M , {n}_{T} ) = \frac{B}{T} = \frac{1}{T} ( 2 ⌊ {log}_{2} ( \begin{matrix}Q \\ P\end{matrix} ) + {Plog}_{2} M ) \qquad ( 8 )$$

where we recall that Q ≙T_{nT} and adopt a notation meant to emphasize that P and T are seen as fundamental QSM design parameters, while M and n_{T} are considered to be system constraints

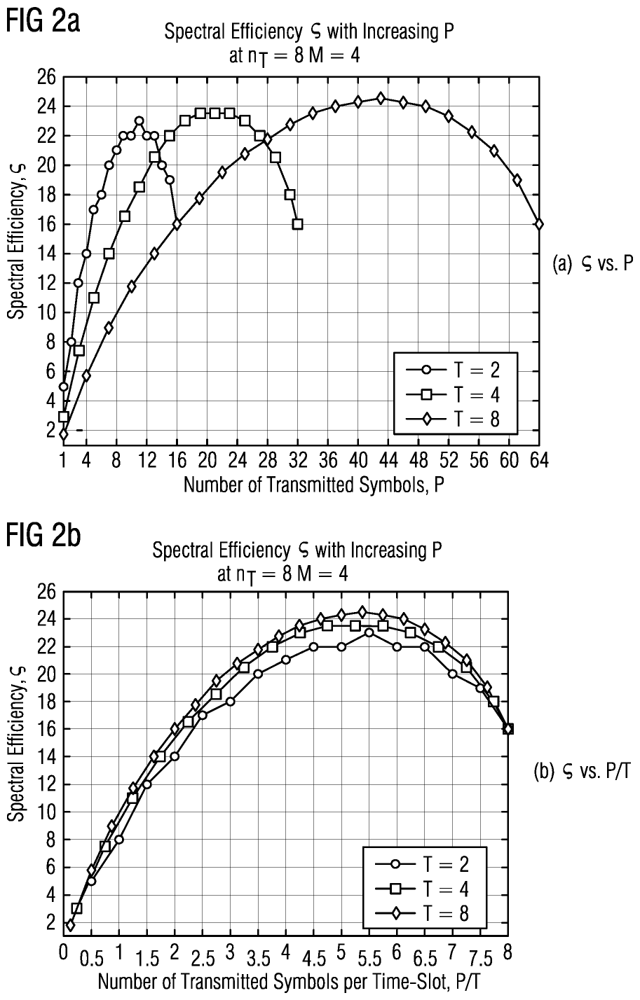

FIG. 2 shows the Spectral efficiency of OS-QSM scheme with T=2, 4, and 8, for a given system with n_{T}=8 and M=4

The presence of the binomial coefficient (_{P}^{Q}) in equation (8) implicates that the SE function ζ(P, T; M, n_{T}) is monotonically descending on T, for a fixed P, and concave on P, for a fixed T, as well as on the ratio P/T. This is well illustrated in the plots offered in FIG. 2, from which it can be seen that in a system with n_{T}=8 and M=4, the highest attainable SEs, denoted by ζ, are achieved with P=11, 21 and 42, for T=2, 4 and 8, respectively.

Motivated by the discussion above, we seek analytical expressions for the optimum ratio P/T that maximizes the SE, given n_{T} and M, which in turn can be used to determine the relative SE reduction incurred in setting T<n_{T} for large-scale systems with n_{T}→∞. To this end, consider the upper and lower-bounds on the binomial coefficient, namely

$$\frac{\text{?} {ε}^{- 1 / 8}}{\sqrt{2 π P}} {( \frac{Q}{Q - P} )}^{Q + \frac{1}{2}} \cdot {( \frac{Q - P}{P} )}^{P} < ( \begin{matrix}Q \\ P\end{matrix} ) < {\overbrace{\frac{1}{\sqrt{2 π P}} {( \frac{Q}{Q - P} )}^{Q + \frac{1}{2}} \cdot {( \frac{Q - P}{P} )}^{P}}}^{{=}^{△} β ( P ; Q )} {\cdot }_{\text{?}} ∀ 1 \leq P \leq Q \text{?} \qquad ( 9 )$$

$$\text{?} \text{indicates text missing or illegible when filed}$$

where for future convenience we implicitly defined the upper-bounding function β(P; Q).

Using equation (9) into equation (8) yields the bound

$$ζ ( P , T ; M , {n}_{T} ) < {\overbrace{\frac{1}{T} {log}_{2} ( {β}^{2} ( P ; Q ) \cdot {M}^{P} )}}^{{=}^{△} {ζ}^{+} ( P , T ; M , {n}_{T} )} \qquad ( 10 )$$

Taking the derivative of the latter expression with respect to P yields

$$\frac{\partial {ζ}^{+}}{\partial P} = \frac{1}{T} \cdot \frac{\partial }{\partial P} [ 2 {log}_{2} ( \frac{1}{\sqrt{2 π P}} {( \frac{Q}{Q - P} )}^{Q + \frac{1}{2}} {( \frac{Q - P}{P} )}^{P} ) + P {log}_{2} ( M ) ] = \frac{1}{Tln ( 2 )} [ 2 ( ln ( \frac{1 - ε}{ε} ) + \frac{1 - 20 ε \text{?}}{2 Q ( z - 1 ) ε} ) + ln ( M ) ] = \frac{1}{Tln ( 2 )} [ ln ( \frac{{( 1 - ε )}^{2} \cdot M}{{ε}^{2}} ) + ( \frac{1 + 2 ε}{Q ε ( ε - 1 )} ) ] \qquad ( 11 )$$

$$\text{?} \text{indicates text missing or illegible when filed}$$

where in the second line we relax the constraint that PεN and expressed more generally P=εQ, introducing the positive quantity ε≤1.

Equating the expression in equation (11) to zero yields the following analytical implicit expression to determine the optimal number of symbols P* that maximizes the SE of a QSM system with Q=T_{nT} spatial-temporal resources and employing an M-ary constellation

$${P}^{*} = ⌊ ε Q ⌋ \vert \frac{2 ε - 1}{( ε - 1 ) ln ( {( \frac{1 - ε}{ε} )}^{2} M )} = ε Q {=}^{△} P , \qquad ( 12 )$$

where we emphasize that the quantity on the righthand side of the expression is in fact sought after number of transmitted symbols P.

But recalling that the desired P* is also the largest possible, equation (12) implies that

$${P}^{*} = ⌊ max ( \frac{2 ε - 1}{( ε - 1 ) ln {( \frac{1 - ε}{ε} )}^{2} M} ) ⌋ \qquad ( 13 )$$

which in turn implies that the optimum ε is such that

$${( \frac{1 - ε}{ε} )}^{2} M = 1 ,$$

i.e., the solution of the quadratic polynomial (M-1)=ε²−2Mε+M, which finally yields, simply

$${P}^{*} = ⌊ \frac{M - \sqrt{M}}{M - 1} Q ⌋ = ⌊ {ε}_{M}^{*} {Tn}_{T} ⌋ \qquad ( 14 )$$

where we introduced the implicitly-defined optimum gradient

$${ε}_{M}^{*} {=}^{△} \frac{M - \sqrt{M}}{M - 1} \text{?} .$$

$$\text{?} \text{indicates text missing or illegible when filed}$$

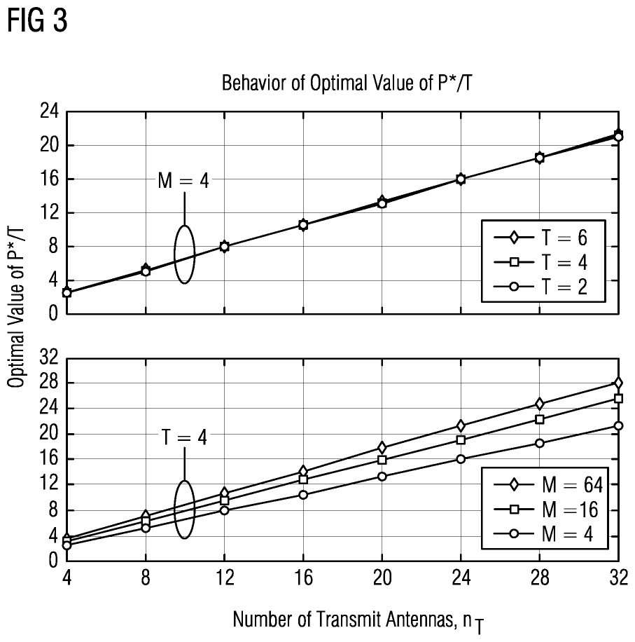

We emphasize that the elegant result offered in equation (14) is general for any QSM scheme. From this result it is seen that the optimum ratio P/T that maximizes the SE of the QSM scheme is linear on the number of transmit antennas n_{T}. In other words, for any given M and n_{T}, an SE-optimum QSM must be such that P/T scales linearly with n_{T}, as illustrated and confirmed by the simulation results shown in FIG. 3.

This means, FIG. 3 showing the effect of T and M on the optimum ratio P*/T between the number of transmit symbols and epochs

Recall also that QSM dispersion matrices are generally constructed with basis on STBCs characterized by T×T square encoding matrices. Consequently, it follows that if P must scale with n_{T} in order for the QSM to be SE-optimal, so must the size T of the code, in order for the the underlying STBC itself to retain SE-optimality. In other words, equation (14) also implicates that in order to achieve SE-optimality, a QSM scheme conveying M-ary symbols must employ an underlying full-rate STBC of a size that scales proportionally to the number of transmit antennas n_{T}

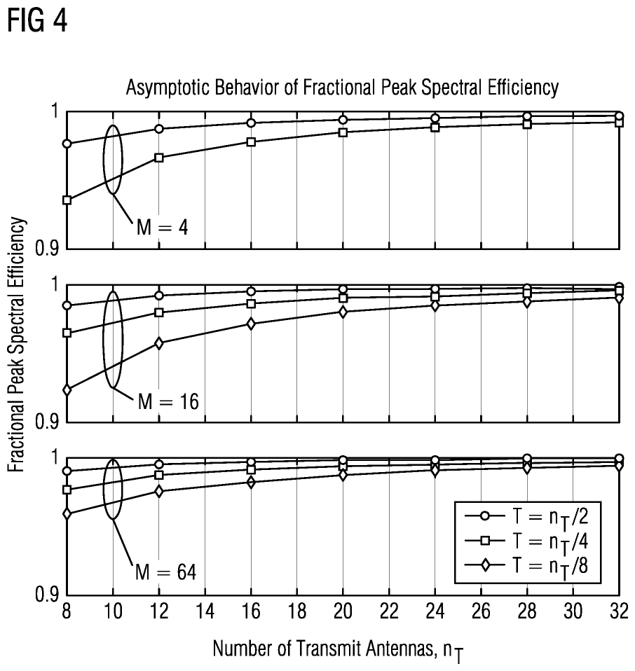

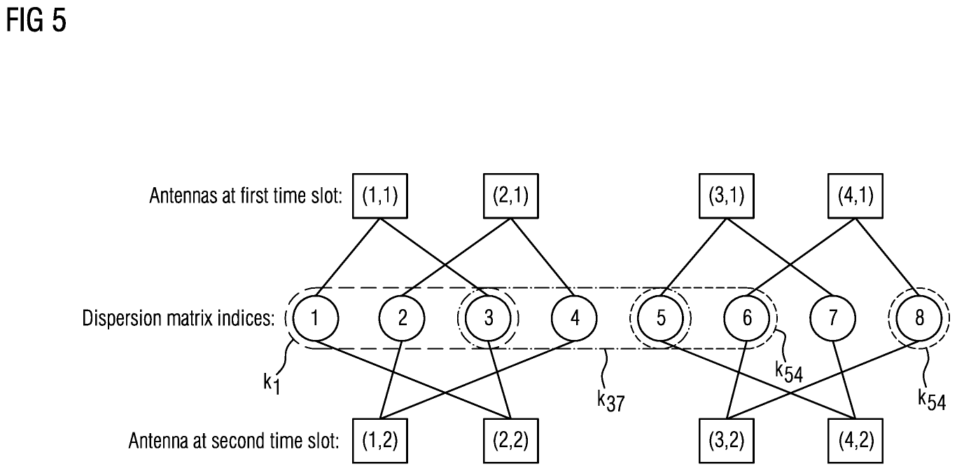

It must be remarked, that setting T=n_{T} is not a scalable proposition, not only because it implies furbishing the transmitter with an equal number of RF chains, which can be prohibitively expensive, but also because it results in fully dense signals, which in turn require also prohibitively complex ML receivers. This observation motivates the comparisons given in FIG. 4, which shows the fraction of the maximum attainable spectral efficiencies ζ occurring at P*, obtained by QSM schemes employing STBCs of different sizes, as a function of n_{T} and for different M. It can be seen that QSM schemes with T sufficiently large, but still significantly less than n_{T}, also asymptotically achieve near optimal SE as long as n_{T} is sufficiently large.

FIG. 4 depicts the Behavior of fractional peak spectral efficiency as a function of n_{T}, for different sizes of T and M.

In view of these results, in the next section it is introduce the a new QSM transmitter design, including both the description of how to construct QSM dispersion matrices based on optimal STBCs of arbitrary size, as well as a new systematic mechanism to obtain the associated set of index vectors used in their selection during transmission. For clarity of explanation, we first take the simpler example of the 2×2 case, to introduce the construction of dispersion index set for optimal diversity gain. The extension of the scheme to generalized T follows subsequently.

### B. Golden (2×2) Dispersion Matrices and Optimal Index Sets

Before describing the proposed dispersion matrix construction let us, without loss of generality and to facilitate comparison with existing methods, impose the assumption that the transmit signal matrix X as per equation (2) satisfies the unity average transmission power constraint for each active transmit antenna, such that [symbol] [tr(X^{H}X)]=PT under constellations with unity average power symbols. Then, consider the 2×2 Golden code, which compactly encodes four symbols {s1, s2, s3, s4} into the matrix.

$${S}_{G} = \frac{1}{\sqrt{5}} [ \begin{matrix}α ( {s}_{1} + {s}_{2} θ ) & α ( {s}_{3} + {s}_{4} θ ) \\ j \overline{α} ( {s}_{3} + {s}_{4} \overline{θ} ) & \overline{α} ( {s}_{1} + {s}_{2} \overline{θ} )\end{matrix} ] \qquad ( 15 )$$

where θ and θ̅ denote the complementary Golden numbers θ=(1+\sqrt{5})/2 and θ̅=(1−\sqrt{5})/2), respectively, and α=: 1+j (1−θ) and α=1+j (1−θ̅) are the optimized coefficients for the Gaussian integer constellation sets.

The construction of QSM dispersion matrices based on the latter Golden code follows from the decomposition of S_{G} into the auxiliary matrices Cᵢ and Dᵢ, which are used to modulate the real part sᵢ^{R} and imaginary part sᵢ^{I} of each i-th symbol encoded, respectively, such that

$${S}_{G} = \frac{1}{\sqrt{5}} {\sum }_{i = 1}^{4} ( {s}_{i}^{R} {C}_{i} + {s}_{i}^{I} {D}_{i} ) \qquad ( 16 )$$

where

$${C}_{1} {=}^{Δ} [ \begin{matrix}α & 0 \\ 0 & \overline{α}\end{matrix} ] , {C}_{2} {=}^{Δ} θ \cdot {C}_{1} , {C}_{3} {=}^{Δ} {J}_{2 , 1} \cdot {C}_{1} \cdot {M}_{2} , \\ {C}_{4} {=}^{Δ} {J}_{2 , 1} \cdot {C}_{2} \cdot {M}_{2} , and {D}_{i} {=}^{Δ} {jC}_{i}$$

With

$$Θ {=}^{Δ} [ \begin{matrix}θ & 0 \\ 0 & θ\end{matrix} ] and {J}_{2 , 1} {=}^{Δ} [ \begin{matrix}1 & 0 \\ 0 & j\end{matrix} ] ,$$

and note that post-multiplying the circular lower-shift matrix Mₙ to a given matrix X results in a column-wise circular shift of X to the left. In possession of the above auxiliary matrices, the Golden dispersion matrices are then built using the Kronecker product operations following a similar strategy namely

$${A}_{q} = {A}_{4 ( ℓ - 1 ) + i} = \sqrt{\frac{2}{5}} {e}_{ℓ} ⊗ {C}_{i} and {B}_{q} = {B}_{4 ( ℓ - 1 ) + i} = \sqrt{\frac{2}{5}} {e}_{ℓ} ⊗ {D}_{i} \qquad ( 18 )$$

Regarding the scaling factor in equation (18), the denominator 1/sqrt(5) is passed over from the coefficient of the Golden code as in equations (15) and (16), while the numerator sqrt(2) is the result of power scaling required to ensure that the transmit power constraint [symbol] [tr (X^{H}X)]]=PT is satisfied. To elaborate further, from equations (2) and (18) it follows that [symbol] [tr (X^{H}x)]]=PT implies that the dispersion matrices must satisfy tr(A_{q}^{H}A_{q})=T and tr(B_{q}^{H}B_{q})=T, for all q∈{1, . . . , Q}, whereas from the construction of the auxiliary matrices Cᵢ and Dᵢ as per equations (17) it is evident that tr(Cᵢ^{H}Cᵢ)=1 and tr(Dᵢ^{H}Dᵢ)=1, such that a power scaling of T=2 onto Cᵢ and Dᵢ, i.e., an amplitude scaling of sqrt (2) onto Cᵢ and Dᵢ, is needed.

The Golden codes are known to outperform the SSB codes employed in the EDA-QSM scheme, while having structure very similar to the latter, such that their utilization in the construction of dispersion matrices as described above is, in and of itself, bound to improve the performance of QSM schemes over those briefly described, as shall be demonstrated later via simulated comparisons.

There is, however, another mechanism to improve the performance of QSM schemes employing STBCs, namely, to optimize the selection of the index vectors in [symbol] ={kn}ₙ₌₁^{N}∈ [symbol] ^{P} that determine which dispersion matrices are assigned to the real and imaginary parts of each encoded symbol. This is because each index vectors kₙ is, according to equations (17) and (18), associated with different subsets of spatial-temporal resources utilized by the QSM scheme in the transmission of a given set of spatially encoded bits. To illustrate the issue, define the set K* of all of all (_{P}^{Q}) distinct index vectors for a given pair (P, Q), and consider the corresponding example compiled in Table I for the case P=3 and Q=2n_{T}=8.

Recall also that each dispersion matrix in the transmission of sₚ^{R} or sₚ^{I} uses two given pairs of antennas and time slots, as per equations (17) and (18), such that for the sake of conciseness it is hereafter referred to each pair of one antenna and one time slot simply as a spatial temporal resource rq, defining also for future convenience the set of all available and utilized spatial temporal resources, denoted respectively by R* and R. Then, if resources and dispersion matrix indices are represented by a rectangular and a circular nodes, respectively, a bipartite graph such as the one shown in FIG. 5 for the case in question (i.e., P=3 and Q=8) can be built, in which an edge connecting a circular and a rectangular nodes indicates that the corresponding resource is used by the given dispersion matrix.

FIG. 5 is the bipartite graph representing the spatial-temporal resource usage associated with each index vector kₙ for a QSM system with P=3 and Q=8. The particular examples of k₁, k₃₇ and k₅₄ are explicitly illustrated.

As illustrated by the graph, the inclusion of a given index set kₙ from K* into the set K is associated with the use of certain resources, occasionally with multiplicity, identified by the graph edges intercepted by the enclosure encircling the corresponding indices. We shall therefore use the notation kₙ⇒rₙ to indicate that the index set kₙ implicates the utilization of the set of resources rₙ, and μₖₙ (rq) to denote the multiplicity of the resource rq in the set kₙ.

For example, the use of the resources r1={2×(1, 1), (1, 2), (2, 1), 2×(2, 2)} results from having k₁=[1, 2, 3] in K, such that it may be written concisely k₁⇒r₁, with μₖ₁ (1, 1)=μₖ₁ (2, 2)=2. Similarly, k₃₇=[3, 4, 5]⇒r₃₇={(1, 1), (1, 2), (2, 1), (2, 2), (3, 1), (4, 2)}, and k₅₄=[5, 6, 8]⇒r₅₄={(3, 1), 2×(3, 2), 2×(4, 1), (4, 2)}, with μᵣ₃₇ (3, 2)=μᵣ₃₇ (4, 1)=2.

It is evident from all the above that in order to avoid redundancy and uneven utilization of spatial-temporal resources, so as to optimize the performance of QSM schemes, the sets of dispersion matrix indices K (with con (i.e., kₙ≢kₘ, ∀n≢m,); [symbol] ) must satisfy the following conditions:
a) no two index vectors kₙ and km in the set can be equal (i.e., kₙ≢kₘ, ∀n≢m);
b) no two elements in each index vector can be equal (i.e., [kₙ]_{q}≢[kₙ]ⱼ, ∀kₙ and i≢j):
c) the utilization of all resources available must be ensured (i.e., [symbol] (r_{q})>0∀r_{q}∈ [symbol] )
d) all resources are utilized as often (i.e. [symbol] (r₁)= . . . = [symbol] (r_{Q})),
e) the cardinality of the set must be a power of 2 in order to enable the encoding of codewords (i.e., N=| [symbol] |=[(_{P}^{Q})]_{2×})

As an example, we highlight in Table I the set of index vectors K={k₁, k₂, k₃, k₅, . . . , k₈, k₁₀, k₁₁, k₁₉, . . . , k₂₃, k₂₆, k₂₇, k₂₈, k₃₅, . . . , k₃₈, k₄₁, k₄₂, k₄₇, k₄₈, k₅₀, . . . , k₅₆}. The reader can verify that by this choice of K, all resources in the associated set R have multiplicity 24. In contrast, a naïve truncation of the first 32 index vectors in Table I, i.e. K={k₁, . . . , k₃₂}, leads to an uneven utilization pattern in which μK (1, 1)=μk(2, 2)=32, μk(1, 2)=μk(2, 1)=28, μk(3, 1)=μk(4, 2)=19 and μk(3, 2)=μk(4, 1)=17, which is obviously sub-optimum as it leads to antennas 1 and 2 being used far more often than antennas 3 and 4. The problem of selecting the optimum set K as described and illustrated above relates to a classic problem in combinatorics graph theory known as the Vertex Cover Problem. In the context hereby, however, the problem has the additional difficulties that: a) the graph in question is bipartite, b) coverage with equal multiplicity is required, and c) nodes must be selected in subsets of three at a time.

TABLE I
Sets of All Possible Index Vectors [symbol] * and Resources [symbol] * (P = 3, n_{T} = 4, T = 2)

| Elements of [symbol] * | | Elements of [symbol] * | Elements of [symbol] * | | Elements of [symbol] * |
|---|---|---|---|---|---|
| k₁ | [1, 2, 3] | (1, 1), (2, 2), (1, 2), (2, 1), (1, 1), (2, 2) | k₂₉ | [2, 4, 7] | (1, 2), (2, 1), (1, 2), (2, 1), (3, 1), (4, 2) |
| k₂ | [1, 2, 4] | (1, 1), (2, 2), (1, 2), (2, 1), (1, 2), (2, 1) | k₃₀ | [2, 4, 8] | (1, 2), (2, 1), (1, 2), (2, 1), (3, 2), (4, 1) |
| k₃ | [1, 2, 5] | (1, 1), (2, 2), (1, 2), (2, 1), (3, 1), (4, 2) | k₃₁ | [2, 5, 6] | (1, 2), (2, 1), (3, 1), (4, 2), (3, 2), (4, 1) |
| k₄ | [1, 2, 6] | (1, 1), (2, 2), (1, 2), (2, 1), (3, 2), (4, 1) | k₃₂ | [2, 5, 7] | (1, 2), (2, 1), (3, 1), (4, 2), (3, 1), (4, 2) |
| k₅ | [1, 2, 7] | (1, 1), (2, 2), (1, 2), (2, 1), (3, 1), (4, 2) | k₃₃ | [2, 5, 8] | (1, 2), (2, 1), (3, 1), (4, 2), (3, 2), (4, 1) |
| k₆ | [1, 2, 8] | (1, 1), (2, 2), (1, 2), (2, 1), (3, 2), (4, 1) | k₃₄ | [2, 6, 7] | (1, 2), (2, 1), (3, 2), (4, 1), (3, 1), (4, 2) |
| k₇ | [1, 3, 4] | (1, 1), (2, 2), (1, 1), (2, 2), (1, 2), (2, 1) | k₃₅ | [2, 6, 8] | (1, 2), (2, 1), (3, 2), (4, 1), (3, 2), (4, 1) |
| k₈ | [1, 3, 5] | (1, 1), (2, 2), (1, 1), (2, 2), (3, 1), (4, 2) | k₃₆ | [2, 7, 8] | (1, 2), (2, 1), (3, 1), (4, 2), (3, 2), (4, 1) |
| k₉ | [1, 3, 6] | (1, 1), (2, 2), (1, 1), (2, 2), (3, 2), (4, 1) | k₃₇ | [3, 4, 5] | (1, 1), (2, 2), (1, 2), (2, 1), (3, 1), (4, 2) |
| k₁₀ | [1, 3, 7] | (1, 1), (2, 2), (1, 1), (2, 2), (3, 1), (4, 2) | k₃₈ | [3, 4, 6] | (1, 1), (2, 2), (1, 2), (2, 1), (3, 2), (4, 1) |
| k₁₁ | [1, 3, 8] | (1, 1), (2, 2), (1, 1), (2, 2), (3, 2), (4, 1) | k₃₉ | [3, 4, 7] | (1, 1), (2, 2), (1, 2), (2, 1), (3, 1), (4, 2) |
| k₁₂ | [1, 4, 5] | (1, 1), (2, 2), (1, 2), (2, 1), (3, 1), (4, 2) | k₄₀ | [3, 4, 8] | (1, 1), (2, 2), (1, 2), (2, 1), (3, 2), (4, 1) |
| k₁₃ | [1, 4, 6] | (1, 1), (2, 2), (1, 2), (2, 1), (3, 2), (4, 1) | k₄₁ | [3, 5, 6] | (1, 1), (2, 2), (3, 1), (4, 2), (3, 2), (4, 1) |
| k₁₄ | [1, 4, 7] | (1, 1), (2, 2), (1, 2), (2, 1), (3, 1), (4, 2) | k₄₂ | [3, 5, 7] | (1, 1), (2, 2), (3, 1), (4, 2), (3, 1), (4, 2) |
| k₁₅ | [1, 4, 8] | (1, 1), (2, 2), (1, 2), (2, 1), (3, 2), (4, 1) | k₄₃ | [3, 5, 8] | (1, 1), (2, 2), (3, 1), (4, 2), (3, 2), (4, 1) |
| k₁₆ | [1, 5, 6] | (1, 1), (2, 2), (3, 1), (4, 2), (3, 2), (4, 1) | k₄₄ | [3, 6, 7] | (1, 1), (2, 2), (3, 2), (4, 1), (3, 1), (4, 2) |
| k₁₇ | [1, 5, 7] | (1, 1), (2, 2), (3, 1), (4, 2), (3, 1), (4, 2) | k₄₅ | [3, 6, 7] | (1, 1), (2, 2), (3, 2), (4, 1), (3, 2), (4, 1) |
| k₁₈ | [1, 5, 8] | (1, 1), (2, 2), (3, 1), (4, 2), (3, 2), (4, 1) | k₄₆ | [3, 7, 8] | (1, 1), (2, 2), (3, 1), (4, 2), (3, 2), (4, 1) |
| k₁₉ | [1, 6, 7] | (1, 1), (2, 2), (3, 2), (4, 1), (3, 1), (4, 2) | k₄₇ | [4, 5, 6] | (1, 2), (2, 1), (3, 1), (4, 2), (3, 2), (4, 1) |
| k₂₀ | [1, 6, 8] | (1, 1), (2, 2), (3, 2), (4, 1), (3, 2), (4, 1) | k₄₈ | [4, 5, 7] | (1, 2), (2, 1), (3, 1), (4, 2), (3, 1), (4, 2) |
| k₂₁ | [1, 7, 8] | (1, 1), (2, 2), (3, 1), (4, 2), (3, 2), (4, 1) | k₄₉ | [4, 5, 8] | (1, 2), (2, 1), (3, 1), (4, 2), (3, 2), (4, 1) |
| k₂₂ | [2, 3, 4] | (1, 2), (2, 1), (1, 1), (2, 2), (1, 2), (2, 1) | k₅₀ | [4, 6, 7] | (1, 2), (2, 1), (3, 2), (4, 1), (3, 1), (4, 2) |
| k₂₃ | [2, 3, 5] | (1, 2), (2, 1), (1, 1), (2, 2), (3, 1), (4, 2) | k₅₁ | [4, 6, 8] | (1, 2), (2, 1), (3, 2), (4, 1), (3, 2), (4, 1) |
| k₂₄ | [2, 3, 6] | (1, 2), (2, 1), (1, 1), (2, 2), (3, 2), (4, 1) | k₅₂ | [4, 7, 8] | (1, 2), (2, 1), (3, 1), (4, 2), (3, 2), (4, 1) |
| k₂₅ | [2, 3, 7] | (1, 2), (2, 1), (1, 1), (2, 2), (3, 1), (4, 2) | k₅₃ | [5, 6, 7] | (3, 1), (4, 2), (3, 2), (4, 1), (3, 1), (4, 2) |
| k₂₆ | [2, 3, 8] | (1, 2), (2, 1), (1, 1), (2, 2), (3, 2), (4, 1) | k₅₄ | [5, 6, 8] | (3, 1), (4, 2), (3, 2), (4, 1), (3, 2), (4, 1) |
| k₂₇ | [2, 4, 5] | (1, 2), (2, 1), (1, 2), (2, 1), (3, 1), (4, 2) | k₅₅ | [5, 7, 8] | (3, 1), (4, 2), (3, 1), (4, 2), (3, 2), (4, 1) |
| k₂₈ | [2, 4, 6] | (1, 2), (2, 1), (1, 2), (2, 1), (3, 2), (4, 1) | k₅₆ | [6, 7, 8] | (3, 2), (4, 1), (3, 1), (4, 2), (3, 2), (4, 1) |

Method 1 Greedy Construction of Optimal Set of Index Vectors K

| | Internal Parameters: Number of resources Q = T · n_{T} and set of all possible indices [symbol] *. |
|---|---|
| | Inputs: Number of symbols P, of transmit antennas n_{T} and dimension T of FDFR STBC. |
| | Outputs: Optimized set of index vectors [symbol] . |
| 1: | Choose a random seed n ϵ {1, . . . , (_{P}^{Q})} and start with [symbol] = ∅; |
| 2: | while \| [symbol] \| ≠ └(_{P}^{Q})┘_{2×} do |
| 3: | Insert kₙ into the set [symbol] of selected index vectors; |
| 4: | Sort all indices k ϵ {1 . . . , Q)} in ascending order of their multiplicities in [symbol] ; |
| 5: | Set D = P and construct/clear the empty set [symbol] = ∅ of candidate index vectors; |
| 6: | while \| [symbol] \| = 0 do |
| 7: | Construct a list [symbol] of candidate indices with the D lowest multiplicities in [symbol] ; |
| 8: | Construct the set [symbol] of all (_{P}^{D}) index vectors \tilde{k}ₘ with indices in k; |
| 9: | Remove from [symbol] all index vectors already in [symbol] ; |
| 10: | if \| [symbol] \| = 0 then |
| 11: | Increment D by 1; |
| 12: | end if |
| 13: | end while |
| 14: | Select next n ϵ {1, . . . , (_{P}^{Q})} as the position of the first index vector \tilde{k}ₘ of [symbol] in [symbol] *; |
| 15: | end while |

Due to these peculiarities, the problem itself is, to the best of our knowledge, original and cannot be solved by known variations of the Vertex Cover algorithm. Fortunately, the highly symmetric structure of the associated bipartite graph can be exploited to design an efficient method to solve the selection problem at hand. To that end, let us commit a slight abuse of notation and define the multiplicity of a dispersion matrix index (notice that there is no ambiguity with the definition of multiplicity of resources because dispersion matrix indices are single numbers, while spatial temporal resources are pairs) q in the set K as μk (q). Then, by virtue of the symmetry of the graph, as it can be seen in FIG. 5, a solution K in which μK (1)= . . . =μK (Q) implies a solution R in which each of the spatial temporal resources {(1, 1), (1, 2), (2, 1), (2, 2), (3, 1), (4, 2)} have the same multiplicity. Consequently, the problem can be solved efficiently by the greedy selection of indices, as described in method 1.

### C. Optimal Generalized Design (T×T)

Due to the greedy optimal index vector selection algorithm described above, which is general on P, T and n_{T}, the last limiting factor preventing the generalization of QSM to arbitrary T is the construction of the dispersion matrices with basis on

STBCs of arbitrary size. This obstacle is eliminated by considering the design of QSM dispersion matrices based on the Perfect FDFR STBC.

A T×T FDFR STBC encodes T² symbols such that the average energy transmitted per antenna is normalized to unity, an energy efficiency-shaping constraint is enforced, and a SE-preserving lower bound on the coding gain (a.k.a, non-vanishing determinant) is maximized. Ultimately, for given T∈N⁺ the design can be described by

$${S}_{P} = {\sum }_{t = 1}^{T} diag ( R \cdot {s}_{t} ) \cdot {J}_{T , i - 1} \cdot {N}_{T}^{i - 1} \qquad ( 19 )$$

where sₜ=[s_{1+(i-1)T}, s_{2+(i-1)T}, . . . , s_{T}]^{T}, with t={1, . . . , T} are vectors each carrying T distinct transmit symbols, R is a T×T optimum lattice generating matrix], J_{T,n} is a T×T matrix constructed by replacing the last n diagonal entries of the identity matrix by the elementary complex number j, and N_{T} is a T×T cyclic upper-shift matrix (notice that J_{T,n} generalizes J_{2,1} used in equation (17). In turn, oppositely to Mₙ, Nₙ is obtained by circularly shifting the top row of Iₙ to the bottom. Some examples are

$${J}_{2 , 0} = [ \begin{matrix}1 & 0 \\ 0 & 1\end{matrix} ] {J}_{3 , 2} = [ \begin{matrix}1 & 0 & 0 \\ 0 & j & 0 \\ 0 & 0 & j\end{matrix} ] N 3 = [ \begin{matrix}0 & 1 & 0 \\ 0 & 0 & 1 \\ 1 & 0 & 0\end{matrix} ] ,$$

such that post-multiplying it to a given matrix X results in a column-wise shift of X to the right.

Notice that the Perfect FDFR STBC fully generalizes the 2×2 Golden code of. To see that, suffice it to consider the case T=2 and with the corresponding lattice generating matrix

$$R = \frac{1}{\sqrt{5}} [ \begin{matrix}α & αθ \\ \overline{α} & \overline{α} \overline{θ}\end{matrix} ] ,$$

such that equation (19) yields

$$\begin{matrix}{S}_{P} = diag ( \frac{1}{\sqrt{5}} [ \begin{matrix}α & αθ \\ \overline{α} & \overline{α} \overline{θ}\end{matrix} ] [ \begin{matrix}{s}_{1} \\ {s}_{2}\end{matrix} ] ) \cdot {J}_{2 , 0} \cdot {N}_{2}^{0} + diag ( \frac{1}{\sqrt{5}} [ \begin{matrix}α & αθ \\ \overline{α} & \overline{α} \overline{θ}\end{matrix} ] [ \begin{matrix}{s}_{3} \\ {s}_{4}\end{matrix} ] ) \cdot {J}_{2 , 1} \cdot {N}_{2}^{1} \\ = \frac{1}{\sqrt{5}} [ \begin{matrix}α ( {s}_{1} + {s}_{2} θ ) & α ( {s}_{3} + {s}_{4} θ ) \\ j \overline{α} ( {s}_{3} + {s}_{4} \ddot{θ} ) & \overline{α} ( {s}_{1} + {s}_{2} \ddot{θ} )\end{matrix} ] = {S}_{G}\end{matrix} \qquad ( 20 )$$

It follows that in order to be employ Perfect FDFR STBCs in the design of QSM, suffice it to decompose the core code structure of equation (19) in terms of corresponding auxiliary dispersion matrices Cᵢ and Dᵢ due to symmetry, namely

$${C}_{i} = {C}_{T ( w - 1 ) + t} = diag ( \dot{R} \cdot {e}_{t} ) \cdot {\dot{J}}_{T , w - 1} , \cdot {\dot{N}}_{T}^{w - 1} and {D}_{i} = {jC}_{i} \qquad ( 21 )$$

where the generalized indices i∈{1, . . . , 72} are constructed systematically on t∈{1, . . . , T} and w∈{1, . . . , T}, and et is the t-th column of I_{T}.

Following this, the full set of dispersion matrices A and B can be built, i.e.,

$${A}_{q} = {A}_{{T}^{2} ( ℓ - 1 ) + i} = γ {e}_{ℓ} ⊗ {C}_{i} and {B}_{q} = {B}_{{T}^{2} ( ℓ - 1 ) + i} = γ {e}_{ℓ} ⊗ {D}_{i} . \qquad ( 22 )$$

where again q∈{1, . . . , Q}, i∈{1, . . . , T2} as from equation (21), e_{I} is the I-th column of I_{L}, but I∈{1, . . . , L} with L=[n_{T}//T], as well as a generalized scaling factor y determined depending on the specific STBC in order to adjust the powers of the dispersion matrices such that tr(A_{q}^{H}A_{q})=T and tr(B_{q}^{H}B_{q})=T.

Next, we turn our attention to the construction of the optimal set of index vectors K, via a straightforward generalization of the method described in Subsection III-B. Indeed, as can be learned by inspecting equation (21), each auxiliary matrix Cᵢ and Dᵢ is a T×T sparse matrix obtained from a cyclic rotation of a diagonal matrix containing only T non-zero elements of R.

Method 2 QSM Signal Generation

| | Internal Parameters: Number of symbols P, transmit antennas n_{T}, time slots T and |
|---|---|
| | spatial-temporal resources Q = T · n_{T}; and cardinalities M = \| [symbol] \|, and N = \| [symbol] \| = └(_{P}^{Q})┘_{2×}; |
| | Global Quantities: Symbol constellation [symbol] , optimum lattice generating matrix R, |
| | sets of dispersion matrices [symbol] = {A_{q}}_{q=1}^{Q} and [symbol] = {B_{q}}_{q=1}^{Q} with A_{q} and B_{q} as in eq. (22), |
| | set of index vectors [symbol] obtained from Algorithm 1. |
| | Input: Information bit sequence b = [b^{R}, b^{J}, b^{S}]; |
| | Outputs: Transmitted signal X. |
| 1: | Select index vector k^{R} as the ([b^{R}]₍₁₀₎ + 1)-th vector in [symbol] ; |
| 2: | Select index vector k^{J} as the ([b^{J}]₍₁₀₎ + 1)-th vector in [symbol] ; |
| 3: | Assign the bits b^{S} to P symbols {s₁, . . . , sₚ} selected from [symbol] , with sₚ = sₚ^{R} + jsₚ^{I}; |
| 4: | Construct X = Σₚ₌₁^{P} (sₚ^{B}Akₚ^{R} +sₚ^{J}Bk_{P}^{I}) as per equation (2) |

Consequently, the associated dispersion matrices obtained from equation (22) are all sparse matrices with only T non-zero entries, corresponding to the T spatial-temporal resources utilized. In other words, while in the Golden QSM scheme of Subsection III-B each dispersion matrix index q is associated with 2 resources, in the Perfect STBC-based construction here described each index q associates to T resources, such that the corresponding bipartite graph illustrated in FIG. 5 is merely expanded to a similar graph with T. n_{T} index (cicular) nodes and T . . . n_{T} resource (rectangular) nodes, with each resource node connected to T index nodes and vice versa. As a result, the greedy strategy described earlier remains valid, as evidenced by the fact that Method 1 applies to general T. Now it is summarized the structure of the proposed scalable QSM scheme in Method 2.

### IV. Proposed Receiver Design

### A. Sparse Formulation of QSM Receivers

Together, Method 1 and 2 introduced above demonstrate that the design of OS-QSM transmitters is possible and tractable. There is, however, no true scalability without feasibility, such that in order to complete the task it is also necessary to show that the proposed OS-QSM design is effectively decodable at reasonable complexity. To put the challenge into context, for given P, M, T and n_{T}, with Q=T . . . n_{T}, an ML receiver would have to go through ([(_{P}^{Q})]_{2×})²·M^{P} combinations of symbols and selected spatial-temporal resources in order to detect a sequence of 2·[log₂(_{P}^{Q})]+P·log₂ M. That means that even for the minimal setting of T=2, P=2 and M=4, a system with n_{T}=8 transmit antennas would require the receiver to go through ([(_{P}^{Q})]_{2×})²·(4)²=16.777.210 combinations in order to decode the corresponding log 2 (16.777.216)=24 bits. In other words, ML decoding is highly impractical in QSM systems, especially in the context of massive MIMO systems.

We emphasize that this challenge applies not only to the OS-QSM scheme of Subsection III-B, but also to current SotA QSM methods, as the example given above is for T=2, which is the size of the core codes used in the latter. We furthermore stress that the utilization of SD receivers is also not viable in scaled cases, because the nature of tree search algorithms still requires excessive computational complexity in large systems. Finally, it is remarked that since convenient properties such as fast-decodability and block-diagonality are known not to be retainable without sacrifice of optimality for STBC of arbitrary size, a scalable detector for QSM schemes cannot rely on such features.

In light of the above, we introduce hereafter a new detection method for QSM schemes which relies neither on tree-search, nor on specific properties of STBCs, and which is completely independent of the infeasible combinatorial factor [(_{P}^{Q})]_{2×}. In addition, given prior information on the encoding construction, the proposed decoder is valid to detect any QSM signal.

The core idea of our approach is to take full advantage of a sparse representation of QSM signals over the entire channel (i.e., for all spatial temporal resources available), assumed known at the receiver. The proposed decoding method then leverages the iterative shrinkage thresholding algorithm (ISTA) to greedily extract symbol and dispersion index estimates, resulting in significantly lower complexities compared to ML and SD-based methods. To that end, first combine equations (1) and (2), and consider the vectorized form of the QSM received signal

$$y {=}^{Δ} vec ( Y ) = \text{} {\overbrace{( {I}_{T} ⊗ H )}}^{{=}^{Δ} {Φ}_{H}} ( {Ξ}_{A} {u}^{R} + {Ξ}_{B} {u}^{I} ) + {\overbrace{vec ( V )}}^{{=}^{Δ} v} = {Φ}_{H} \cdot ( {Ξ}_{A} {u}^{R} + {Ξ}_{B} {u}^{I} ) + v ∈ {ℂ}^{{Tn}_{H} / 1} \qquad ( 23 )$$

where we implicitly defined the block-diagonal channel matrix OH and vectorized noise v; the dispersion matrices in A and B are also vectorized into a_{q}-≙vec(A_{q}) and b_{q} ≙vec (B_{q}) and concatenated Ξ_{A}≙[a₁, . . . , a_{g}]∈ [symbol] ^{Q×Q} and Ξ_{B}=[b₁, . . . , b_{Q}]∈ [symbol] ^{Q×Q} respectively; and uⁿ∈ [symbol] ^{Q×1} (respectively u^{I} ∈ [symbol] ^{Q×1}) is set to zero everywhere, except for its elements of indices k^{R} ∈ [symbol] (respectively k^{I} ∈ [symbol] ), which are set to {S₁^{R}, . . . , s_{P}^{R}} (respectively {S₁^{I}, . . . , S_{P}^{I}})

Equation (23) can be further simplified by defining the combined and real-imaginary decoupled information and noise vectors

$$u {=}^{Δ} {[ {u}_{1}^{R} , {u}_{1}^{I} , … , {u}_{Q}^{R} , {u}_{Q}^{I} ]}^{T} ∈ {ℝ}^{2 Q \times 1} and v {=}^{Δ} [ {v}_{1}^{R} , {v}_{1}^{I} , … , {v}_{{Tn}_{R}}^{R} , {v}_{{Tn}_{R}}^{I} ] \qquad ( 24 )$$

as well as the decoupled versions of a_{q} and b_{q}, namely

$${a}_{q} {=}^{Δ} {[ {a}_{{q}_{1}}^{R} , {a}_{{q}_{1}}^{I} , … , {a}_{{q}_{Q}}^{R} , {a}_{{q}_{Q}}^{I} ]}^{T} and {b}_{q} {=}^{Δ} {[ {b}_{{q}_{1}}^{R} , {b}_{{q}_{1}}^{I} , … , {b}_{{q}_{Q}}^{R} , {b}_{{q}_{Q}}^{I} ]}^{T} \qquad ( 25 )$$

which in turn can be combined into a single dispersion matrix Ψ_{D} ∈ [symbol] ^{2Q×2Q}, namely

$${Ψ}_{D} {=}^{Δ} [ {a}_{1} , {\overline{b}}_{1} , {a}_{2} , {\overline{b}}_{2} , … , {a}_{Q} , {b}_{Q} ] . \qquad ( 26 )$$

such that the vectorized system model of equation (23) can be re-written as

$$y = {{Φ}^{⋁}}_{H} {Ψ}_{D} \cdot u + υ = {Φ}_{H} \cdot {Ψ}_{D} \cdot u + υ = G \cdot u + υ ∈ {ℝ}^{2 {Tn}_{R} \times 1} \qquad ( 27 )$$

where \check{Φ}_{H} is the quadrature-operated block diagonal channel matrix Φ_{H} which we implicitly relabeled Φ_{H}, as with the effective channel matrix G≙Φ_{H}·Ψ_{D}, for future convenience.

To elaborate on equation (27) with an example, consider a system with P=3, T=2 and n_{T}=4, and assume that for a particular bit sequence b=[b^{R}, b^{I}, b^{s}], the selected index vectors are given by k^{R}=k₁₀=[1, 3, 7] and k^{I}=k₄₇=[4, 5, 7]. Then, the corresponding combined information vector becomes u=[S₁^{R}0, 0, 0, S₂^{R}, 0, 0, S₁^{I}, 0, S₂^{I}, 0, 0, S₃^{R}, S₃^{I}, 0, 0]^{T} Notice that while u carries in the entries s_{P}^{R} and s_{P}^{I} the Plog₂ M bits corresponding to the b^{s} subsequence, the remaining 2 log₂ N bits corresponding to the subsequences b^{R} and b^{I} are encoded merely by positions of non-zero elements in u, regardless of what the values of S_{P}^{R} and s_{P}^{I} might be, which suggests that the detection of b^{s} could be done separately from that of b^{R} and b^{I}.

In principle, the latter feature could be utilized to design an SD receiver for the OS-QSM method proposed above, similarly to how block-separability was exploited to do so for the EDA-QSM scheme. The problem with that approach is, of course, the prohibitively large number of combinations how the 2P elements of the decoupled symbol vector S=[S₁^{R}, S₁^{I}, . . . , S_{P}^{R}, S_{P}^{I}] can be placed among the 2Q entries of u. In order to circumvent this challenge, we instead seek to exploit the facts demonstrated in Subsection III-A, namely, that: a) the optimum number P* of symbols maximizing SE is a fraction of the total spatial-temporal resources Q=T·n_{T}, as per equation (12); and b) that in large-scale systems with n_{T}>>1, a significantly smaller block size T suffices to asymptotically achieve SE optimality, as shown in FIG. 4. Together, these facts imply that the sparsity of u becomes increasingly more prominent in large-scale SE-optimal QSM schemes, which in turn favors sparse recovery algorithms. It is also evident from the inspection of equation (27) that the matrices Φ_{H} and Φₚ can be respectively interpreted as the sensing and dictionary matrices typical of compressive sensing (CS) models, such that recent progress on sparse and discrete-aware receivers can be leveraged.

Taking into account the focus on scalability, which at the receiver side translates to controlling complexity, two suitable candidate methods to be applied for OS-QSM demodulation are the generalized approximate message-passing (GAMP) algorithm, and the iterative shrinkage thresholding algorithm (ISTA), both of which possess quadratic complexity on the size 2T_{nT} of the signal vector u. It is well-known, however, that the GAMP algorithm relies strongly on the particular structure of measurement matrix and the independence of the received signal, which in the case of QSM cannot be generally assumed, as a direct consequence of the utilization of STBCs in the dispersion matrices. In the absence of the required conditions, GAMP receivers yield poor performance, characterized by error-floors at high SNRs.

Motivated by this fact, it is therefore chosen to follow a ISTA-based approach in the design of a low-complexity demodulator for QSM systems, which is described in the sequel. In particular, it is introduced a method to detect QSM signals, which is based on a purpose-built variation of ISTA that incorporates modifications both on the thresholding function and on the index vector estimation process, specifically to QSM detection.

### B. Greedy Boxed ISTA-based QSM Decoder

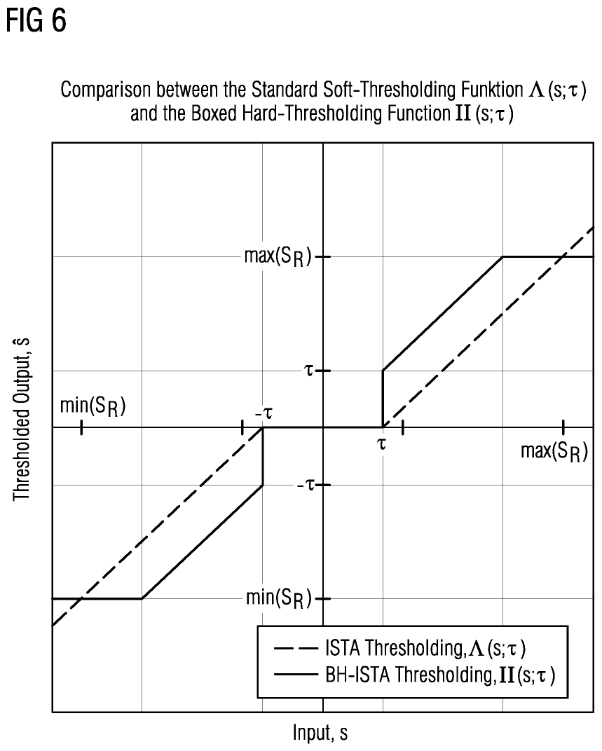

Consider the standard ISTA recursion,

$${\hat{u}}^{( η + 1 )} = Λ ( \text{?} + \frac{1}{α} {G}^{T} ( y - G {\hat{u}}^{( η )} ) ; \frac{λ}{2 α} ) \qquad ( 28 )$$

$$\text{?} \text{indicates text missing or illegible when filed}$$

where u ( ) is the estimate of u at the n-th iteration, α=maxeig (G^{T}G) is the shrinkage step size (the actual requirement is that α>maxeig (G^{T}G), however, we will assume the minimum step-size, which is sufficient), λ is the threshold factor, and Λ(s; T) is the soft-thresholding function. A first meaningful modification to such standard ISTA recursions in equation (28) is to account for the fact that the symbols in the real-valued projected constellation S_{R} ≙ [symbol] (S) are finite, such that in addition to the lower limit T in the vicinity of the origin used to enforce sparsity in the solution, an upper limit max (S_{R}) can be introduced into the thresholding function. In other words, for the case at hand we replace ISTA's standard soft-thresholding function Λ(s; T) by a hard-thresholding function leading to the “boxed” hard-thresholding function Π(s; T) illustrated in FIG. 6 and defined by

$$Π ( s ; τ ) \hat{=} \{ \begin{matrix}min ( {S}_{R} ) & s \leq min ( {S}_{R} ) , \\ s & min ( {S}_{R} ) \leq s \leq - τ , \\ 0 & \vert s \vert \leq τ , \\ s & τ \leq s \leq max ( {S}_{R} ) , \\ max ( {S}_{R} ) & max ( {S}_{R} ) \leq s .\end{matrix} \qquad ( 29 )$$

FIG. 6 is the Comparison of ISTA thresholding and BH-ISTA thresholding functions Λ(s; T), and Π(s; T), (29)

Incorporating this modification yields the boxed-hard ISTA (BH-ISTA) receiver described by

$${\hat{u}}^{( η + 1 )} = Π ( \text{?} + \frac{1}{α} {G}^{T} ( y - G {\hat{u}}^{( η )} ) ; \frac{λ}{2 α} ) \qquad ( 30 )$$

$$\text{?} \text{indicates text missing or illegible when filed}$$

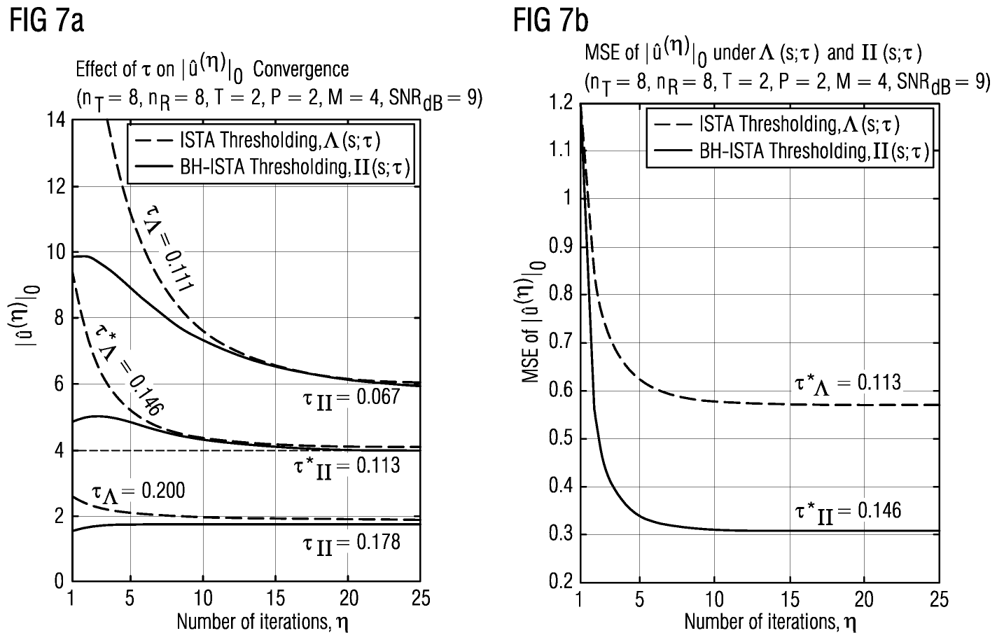

Notice that the computational cost of repeatedly evaluating equation (30) is dominated by the term Gû⁽ⁿ⁾, therefore quadratic on the number of non-zero entries (i.e., l₀-norm) of û⁽ⁿ⁾, which reduces with the iterations n, as illustrated in FIG. 7.

FIG. 7 shows the Convergence of û_{Π}⁽ⁿ⁾ and û_{Λ}⁽ⁿ⁾, as per equations (28) and (30), respectively, as a function of iterations n
FIG. 7 (a) is the Sparsity convergence with various threshold values
FIG. 7 (b) is the MSE convergence with optimal threshold values

In particular, FIG. 7 (a) shows a comparison of the convergence of |û⁽ⁿ⁾|_{D} as a function of n for various values of threshold parameter T, with û⁽ⁿ⁾obtained both from equations (28) and (30), i.e., via conventional and BH-ISTA, respectively, which for convenience will be hereafter denoted û_{Π}⁽ⁿ⁾ and û_{Λ}⁽ⁿ⁾.

It can in fact be seen that as a result of boxing and hard-thresholding, |û_{Π}⁽⁰⁾|₀<|û_{Λ}⁽⁰⁾|₀, such that the expected order of complexity associated with evaluating equation (28) is lower than that of evaluating (30), which can be bounded both below and above by the lower- and upper-limits (O(4P²) and O(4Q²)).

More details will be given in Section V-A. In turn, FIG. 7 (b) shows that the mean-squared error (MSE) obtained with the proposed BH-ISTA approach is better than that obtained with conventional ISTA, which illustrates the effectiveness of the boxed and hard-thresholding modification here proposed for the demodulation of QSM signals. It is left for us to address, however, how the bits associated with the choices of dispersion matrix indices {k^{R}, k^{I}}∈K can be efficiently detected. To that end, another addition is introduced to the ISTA-based sparse detector, namely, a greedy hard-detection procedure for each symbol recovered, with a concomitant update of equation (30), which can be described as follows.

Let us consider that multiple runs of the BH-ISTA iterations described by equation (30) are performed, such that prior to the m-th run a modification is made to y, G and u, which can be expressed by rewriting equation (30) as

$${\hat{u}}_{m}^{( η + 1 )} = Π ( {\hat{u}}_{m}^{( η )} + \frac{1}{α} {G}_{m}^{T} ( {y}_{m} - {G}_{m} {\hat{u}}_{m}^{( η )} ) ; \frac{λ}{2 α} ) \qquad ( 31 )$$

$${\hat{u}}_{1}^{( 1 )} = {0}_{2 Q} .$$

where we convene that for the first run (m=1) we set y₁=y, G₁=G and

Let n* be the last iteration of the m-th run of the latter estimator, with its corresponding outcome denoted by ûₘ^{(n*)}. And finally, let sa \tilde{s}_{qm} be the entry of ûₘ^{(n*)} with the largest amplitude whose position is denoted by \hat{q}ₘ, such that we may write

$$\text{?} = \{ [ \text{?} ] \vert \vert [ {\hat{u}}_{m}^{( {η}^{*} )} \text{?} \vert > \vert [ \text{?} ] \vert , \qquad ( 32 )$$

$$∀ ℓ ∈ \{ 1 , … , 2 Q \} \}$$

$$\text{?} \text{indicates text missing or illegible when filed}$$

where [x]] denotes the I-th element of a generic vector x. It is emphasize that in the greedy procedure summarized by equation (32), two distinct pieces of information on the bit sequence b are obtained, namely, a soft estimate \tilde{S}_{qm} of one of the modulated symbols {S_{P}^{R}, s_{P}^{I}}∈S., and a hard estimate \hat{q}ₘ, of one of the indices contained in the selected index sets {k^{R}, k^{I}}∈K. In possession of such information, the following steps are then executed in order to produce the modified quantities required to perform the next run of the BH-ISTA recursion described by equation (31).

First, a hard-detected version of \tilde{s}ₘ is obtained by projecting in onto S_{R}, that is

$$\text{?} = {P}_{{S}_{R}} ( \text{?} ) \qquad ( 33 )$$

$$\text{?} \text{indicates text missing or illegible when filed}$$

Then, the remaining quantities are updated following

$${\hat{u}}_{m + 1}^{( 1 )} = ( {I}_{2 Q} - diag ( \text{?} ) ) \text{?} , \qquad ( 34 )$$

$${y}_{m} + 1 = {y}_{m} - {G}_{m} \cdot {e}_{{\hat{q}}_{m}} {\hat{s}}_{{\hat{q}}_{m}}$$

$$and$$

$${G}_{m + 1} = {G}_{m} ( {I}_{2 Q} - diag ( {e}_{{\hat{q}}_{m}} ) ) ,$$

$$\text{?} \text{indicates text missing or illegible when filed}$$

where I_{2Q} is the identity matrix of size 2Q and e_{\hat{q}m} its \hat{q}ₘ column. Recall that due to the quadrature-decomposed structure of the sparse vector u, all odd index estimates q\hat{ }m correspond to the real parts of modulated symbols, while even \hat{q}ₘ correspond to the imaginary parts, respectively. It is therefore sensible that, as equations (31) through (35) are evaluated iteratively, the obtained index estimates {\hat{q}₁, \hat{q}₂, . . . , \hat{q}ₘ} be split and collected accordingly into the subsequences

$$\text{?} \hat{=} \{ \text{?} \vert mod ( \text{?} , 2 ) = 1 , ∀ m \} \qquad ( 35 )$$

$$and$$

$$\text{?} \hat{=} \{ \text{?} \vert mod ( \text{?} , 2 ) = 0 , ∀ m \}$$

$$\text{?} \text{indicates text missing or illegible when filed}$$

where mod (x, 2) denotes the modulo-2 operation onto x.

If there are no errors during the detection process, after exactly m=2P runs, the sequences {\hat{q}ₘ^{R}, \hat{q}ₘ^{I}} can be perfectly mapped to {k^{R}, k^{I}}, in particular via

$${\hat{k}}^{R} = \frac{1}{2} ( {\hat{q}}_{m}^{R} + 1 ) \qquad ( 36 )$$

$$and$$

$${\hat{k}}^{I} = \frac{1}{2} {\hat{q}}_{m}^{R}$$

such that procedure comes to a stop.

More generally, however, errors may occur, such that either \hat{q}ₘ^{R} or \hat{q}ₘ^{I}, or both, contain incorrect indices even with cardinality P. In such cases, the procedure continues until both subsequences contains the first P-tuple of indices included in the dispersion matrix index vector set K, at which point a modification of the update equations is required, which can be described as follows.

Let Pₖ (q) denote the projection of a sequence q onto the set K, such that either a sequence k∈K or the empty set Ø is returned by the projection, depending on whether or not q contains within it a sequence from K. If multiple valid k∈K exist in the combination of elements in the viable elements with lower indices in q (not of the element values themselves) take priority, such that the notion of greedy selection is coherent. Then, equation (34) can be expanded into

$$( 37 )$$

$${\hat{u}}_{m + 1}^{( 1 )} = \{ \begin{matrix}[ {I}_{2 Q} - {\sum }_{q ∈ odd} diag ( {e}_{q} ) ] {\hat{u}}_{m}^{( {η}^{*} )} & upon confirmation of {\hat{k}}^{R} from {\hat{q}}_{m}^{R} , & or \\ [ {I}_{2 Q} - {\sum }_{q ∈ even} diag ( {e}_{q} ) ] {\hat{u}}_{m}^{( {η}^{*} )} & upon confirmation of {\hat{k}}^{I} from \text{?} , & or \\ [ {I}_{2 Q} - {\sum }_{q ∈ odd} diag ( {e}_{q} ) ] {\hat{u}}_{m}^{( {η}^{*} )} & otherwise \text{?} & \end{matrix}$$

$$\text{?} \text{indicates text missing or illegible when filed}$$

In plain words, equation (37) establishes that after the m-th run of the BH-ISTA detector, the initial state of the estimate vector ûₘ₊₁^{(I)} for the next run is either:
a) updated by removing the latest estimate symbol, when neither of \hat{q}ₘ^{R} and \hat{q}ₘ^{I} can be projected to K, which happens either when the number of indices acquired are insufficient (less than P) to decide on valid estimates of k^{R} or k^{I} or when the number of indices are sufficient (P or larger) but none contains valid combinations of indices to any k∈K; or
b) updated by nulling all odd entries of q∈{1, 3, . . . , 2Q-3, 2Q-1}, when a hard decision of k″ is confirmed from the projection of \hat{q}ₘ^{I} onto K, which will only happen once throughout the demodulation procedure; or c) updated by nulling all even entries q∈{2, 4, . . . , 2Q-2, 2Q}, when a hard-decision of \hat{k}^{R} is confirmed from the projection of \hat{q}^{R} onto K, which also can happen only once throughout the demodulation procedure; or.
c) updated by nulling all even entries q∈{2, 4, . . . , 2Q-2, 2Q}, when a hard-decision of \hat{k}ₘ^{I} is confirmed from the projection of ĝₘ^{I} onto K, which also can happen only once.

Obviously, the only other alternative to those above is when both \hat{k}^{R} and \hat{k}^{I} have been acquired, and consequently also the entire set of symbol estimates {S₁^{R}, s₁^{I}, . . . , s_{P}^{R}, S_{P}^{I}} have been obtained, in which case the procedure is terminated.

Similarly to the above, the updates of ym and Gm must also be revised so as to account for the effect of hard-decisions onto \hat{k}^{R} and \hat{k}^{I}, so as to cancel the effect of hard-decided indices and symbols, and to nullify the channel corresponding to confirmed indices, yielding respectively

$${y}_{m + 1} = \{ \begin{matrix}y - G \cdot \text{?} & upon confirmation of {\hat{k}}^{R} from {\hat{q}}_{m}^{R} , & or \\ y - G \cdot \text{?} & upon confirmation of {\hat{k}}^{I} from \text{?} , & or \\ {y}_{m} - {G}_{m} \cdot {e}_{{q}_{m}} \text{?} & otherwise . & \end{matrix} \qquad ( 38 )$$

$$( 39 )$$

$${G}_{m + 1} = \{ \begin{matrix}{G}_{m} [ {I}_{2 Q} - {\sum }_{q ∈ odd} diag ( {e}_{q} ) ] & upon confirmation of {\hat{k}}^{R} from {\hat{q}}_{m}^{R} , & or \\ {G}_{m} [ {I}_{2 Q} - {\sum }_{q ∈ even} diag ( {e}_{q} ) ] & upon confirmation of {\hat{k}}^{I} from {\hat{q}}_{m}^{I} , & or \\ {G}_{m} [ {I}_{2 Q} - diag ( \text{?} ) ] & otherwise . & \end{matrix}$$

$$\text{?} \text{indicates text missing or illegible when filed}$$

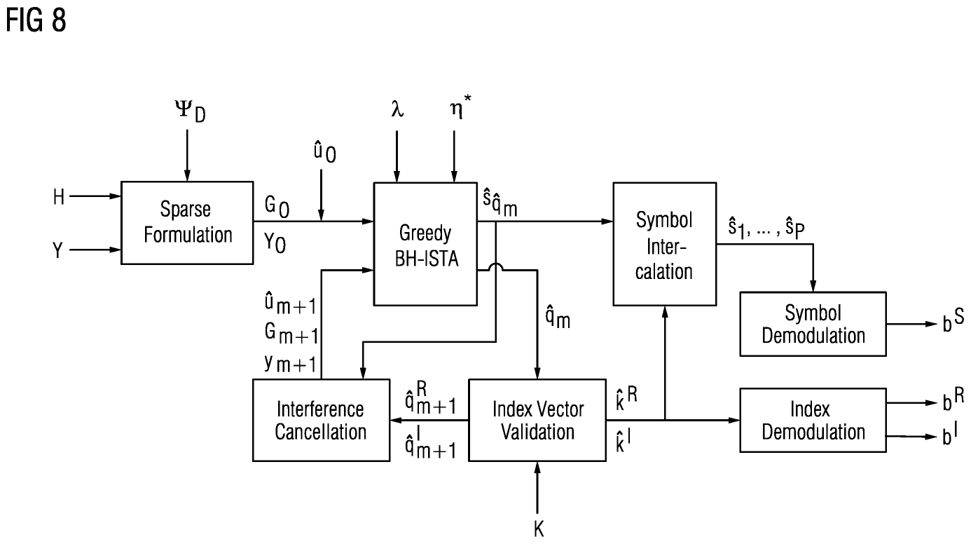

FIG. 8 is the Schematic diagram depicting the structure of the proposed GB-ISTA receiver for QSM demodulation

The procedure described by equations (31) through (33) and (35) through (39) amount to a greedy—i.e., symbol-by-symbol and index set-by-index set—modification of the GB-ISTA detector introduced earlier, for which it is dubbed as the greedy boxed iterative shrinkage thresholding algorithm for QSM demodulation.

Notice that at the end of the process, estimates \hat{k}^{R} and \hat{k}^{I} of the selected dispersion matrix index vectors, as well as hard-decision estimates ŝ=[S₁^{R}, s₁^{I}, . . . , s_{P}^{R}, S_{P}^{I}] of the modulated symbols are obtained, from which the corresponding encoded bits b=[b^{R}, b^{I}, b^{s}] can be retrieved at a fraction of the complexity of sphere detection or exhaustive maximum likelihood searches. A diagram illustrating the proposed GB-ISTA QSM receiver is offered in FIG. 8 and a summarized in the form of pseudo-code in Method 3. FIG. 8 is the schematic diagram depicting the structure of the proposed GB-ISTA receiver for QSM demodulation

Method 3 Greedy Boxed-(Hard) ISTA Receiver for QSM Schemes

| | |
|---|---|
| | Global Quantities: Real-valued projected symbol constellation [symbol] _{R}, set of index vectors [symbol] |
| | and threshold factor λ: |
| | Inputs: Received signal y and effective channel matrix G. |
| | Outputs: Estimated index and symbol vectors \hat{k}^{R}, \hat{k}^{l} and ŝ. |
| 1: | Set m = 1 and α = maxeig(G^{T}G); |
| 2: | Initialize yₘ = y, Gₘ = G and uₘ^{(l)} = 0_{2Q}; |
| 3: | while [symbol] (½[qₘ^{R} + 1]) = ∅ or [symbol] (½qₘ^{l}) = ∅ do |
| 4: | Iterate equation (31) until convergence obtaining ûₘ⁽ⁿ*⁾ |
| 5: | Obtain symbol soft estimate [symbol] and index hard estimate \hat{q}ₘ via equation (32); |
| 6: | Obtain hard symbol estimate [symbol] via equation (33); |
| 7: | Insert index estimate \hat{q}ₘ into its subsequence \hat{q}ₘ^{R} or \hat{q}ₘ^{J} as per equation (35); |
| 8: | Construct ûₘ₊₁⁽¹⁾, yₘ₊₁ and Gₘ₊₁ via equations (37), (38) and (39); |
| 9: | Increment m by 1; |
| 10: | end while |
| 11: | Output the estimate index vectors as \hat{k}^{R} ← [symbol] (½[\hat{q}ₘ^{R} + 1]) and \hat{k}^{l} ← [symbol] (½\hat{q}ₘ^{J}), respectively. |
| | and the estimate symbol vector ŝ as the intercalation of { [symbol] } and { [symbol] }. |

Method 4a Greedy ISTA Decoder

| | Inputs: Received signal: y. Channel matrix: \ddot{H}, Iteration limit: [symbol] , Threshold factor: λ | | |
|---|---|---|---|
| | Symbol constellation: C | | |
| | Outputs: Estimated symbols vector: \hat{x}. Estimated index vectors \hat{k} and [symbol] . | | |
| 1: | \hat{k} = [ ], \hat{l} = [ ], \hat{x} = [ ] . | | |
| 2: | [symbol] = [ ], [symbol] = [ ], ŝ = 0 [symbol] | 13: | if iₘₐₓ is even then |
| | and [symbol] as the unique integer parts of C. | 14: | [symbol] = [ [symbol] , iₘₐₓ/2], |
| 3: | while \hat{k} or \hat{l} == [ ] do | 15: | \hat{k} = index_est( [symbol] ), as given in Algorithm 2. |
| 4: | Set [symbol] = 0, s [symbol] = 0 [symbol] | 16: | else |
| 5: | while t ≤ t [symbol] do | 17: | [symbol] = [ [symbol] , {iₘₐₓ − 1}/2]. |
| 6: | s [symbol] = [symbol] | 18: | \hat{l} = index_est( [symbol] ), as given in Algorithm 2. |
| 7: | t = t + 1. | 19: | end if |
| 8: | end while | | |
| 9: | tₘₐₓ ← equation (17) | 20: | end while |
| 10: | [symbol] = [symbol] . | 21: | for p in [l, . . . , P] do |
| 11: | y = y − {\ddot{H}} [symbol] · [symbol] , | 22: | x = [x, [symbol] + [symbol] ] |
| 12: | {\ddot{H}} [symbol] = 0 [symbol] , | 23: | end for |

[symbol]

indicates data missing or illegible when filed

Method 4b Dispersion Indices Decider: index_est(·)

```
    Inputs: Detected indices vector i
    Outputs: Estimated index vector \hat{v}.
  1: n = numel(i).
  $2 : Compute C , an ( \begin{matrix}n \\ P\end{matrix} ) combination matrix of i .$
  3: Sort each row in C in ascending order,
  4: Compute e via a row-wise base-2n_{T} vector to base-10 scalar
    conversion of C.
  $5 : Compute R , an ( \begin{matrix}n \\ P\end{matrix} ) combination maxtrix of [ 1 , … , n ] .$
  6: r = R·1_{P×i}
  7: m = argmin(r_{μ}) s.t. c_{μ}, ≤ f(Q, P),
  $8 : \hat{v} = \{ \begin{matrix}[ μ ] & if no solution for m \\ {\{ C \}}_{m \to } + {1}_{1 \times P} & otherwise\end{matrix}$
```

In the following table the Spectral efficiency n of the n×n generalised EDA-QSM is shown.

TABLE 1
selected combinations of n, (n_{T}, n_{R}, P),
spectral efficiency η, and sparsity s

| (n_{T}, n_{R}, P) | n | η | s | (n_{T}, n_{R}, P) | n | η | s |
|---|---|---|---|---|---|---|---|
| (4, n_{R}, 1) | 2 | 4 | ⅛ | (8, n_{R}, 4) | 4 | 9.5 | ⅛ |
| (4, n_{R}, 2) | 4 | 4 | ⅛ | (4, n_{R}, 4) | 2 | 10 | ½ |
| (32, n_{R}, 1) | 4 | 4 | 1/128 | (16, n_{R}, 2) | 2 | 10 | 1/16 |
| (4, n_{R}, 2) | 2 | 6 | ¼ | (32, n_{R}, 3) | 4 | 10.5 | 3/128 |
| (4, n_{R}, 3) | 4 | 6 | ⅜ | (16, n_{R}, 4) | 4 | 11.5 | 1/16 |
| (16, n_{R}, 1) | 2 | 6 | 1/32 | (8, n_{R}, 3) | 2 | 12 | 3/16 |
| (4, n_{R}, 4) | 2 | 7 | ½ | (32, n_{R}, 2) | 2 | 12 | 1/32 |
| (32, n_{R}, 1) | 2 | 7 | 1/32 | (32, n_{R}, 4) | 4 | 13.5 | 1/32 |
| (32, n_{R}, 2) | 4 | 7 | 1/64 | (8, n_{R}, 4) | 2 | 14 | ¼ |
| (8, n_{R}, 3) | 4 | 7.5 | 3/32 | (16, n_{R}, 3) | 2 | 15 | 3/32 |
| (4, n_{R}, 3) | 2 | 8 | ⅜ | (16, n_{R}, 2) | 4 | 19 | ⅛ |
| (8, n_{R}, 2) | 2 | 8 | ⅛ | (32, n_{R}, 4) | 2 | 23 | 1/16 |
| (16, n_{R}, 3) | 4 | 9 | 3/64 | | | | |

Compare the pairs where n and P are increased by the same factor, keeping the same sparsity for a given n_{T}
(4, n_{R}, 1), n=2, n=4, s=1/8
(4, n_{R}, 2), n=4, n=4, s=1/8

The striking and novel result is observed when comparing this effect with larger increase in P:
(4, n_{R}, 2), n=2, n=6, s=1/4
(4, NR, 4), n=4, n=7, s=1/4

At same ‘average sparsity’ in time, the spectral efficiency increased with n, and more largely for larger n_{T}!!
(16, n_{R}, 2), n=2, n=10, s=1/16
(16, n_{R}, 4), n=4, n=11.5, s=1/16

### V. Complexity and Performance Analysis

In this section we analyze the performance of the proposed OS-QSM via computer simulations. Given that our focus is on the scalability of the system, all simulation results to be shown are for relatively large number of transmit antennas (i.e., n_{T}≥6) and for increasing number of transmission slots (i.e., T≥2), with the number of digitally-modulated transmit symbols P and the cardinality of corresponding constellation M adjusted on a case-by-case basis in order to highlight the main finding of each simulated experiment. To the best of our knowledge, simulation results on QSM schemes with such parameters have not appeared so far in the literature, due to the prohibitive computational complexity of existing receivers

### A. Complexity: GB-ISTA Versus ML and SCMB-SD Receivers

In light of the latter remark, let us start by assessing the decoding complexity of scaled QSM systems, in particular by deriving the complexity orders of the conventional ML and SCMB-SD approaches, and of the proposed GB-ISTA algorithm described in Section IV.

For any given n_{T}, T and P, the brute-force ML decoder requires a search among all possible [(_{P}^{TRP})]₂, antenna activation patterns, independently selected according to {k^{R}, k^{I}}∈K to transmit the real and imaginary parts of the P digitally modulated symbols in s∈S^{P}, as well as another search, for each possible activation pattern, of all possible P-tuples of symbols selected from the constellation S of cardinality M. Assuming, idealistically and for simplicity, that each search consumes a single floating point operation (flop), the ML search process alone yields a complexity order lower-bounded by O(4^{[log}^{₂}⁽^{_{P}}^{Tmp)]}×M^{P}) in order to detect 2·[log₂(_{P}^{Tn}^{_{T}})]+P·log₂ M bits, which even for moderately small P and M quickly become unfeasible. For example, a search over 16.777.216 combinations is required to detect the 24 bits of each transmit signal in a relatively small system with n_{T}=6, T=3, P=3 and M=4. Just doubling the number of transmit antennas to n_{T}=12, with other parameters unchanged, the complexity of the ML search space already surges to 109 combinations, for a mild increase to 30 bits per transmission, while keeping n_{T}=6 and doubling the number of transmit symbols to P=6 requires a search over more than 1012 combinations in order to detect only 40 bits. Taking the most significant operations required to perform each ML search into account, the order of complexity of the ML receiver to decode each bit of QSM schemes becomes with the lower bound obtained by keeping only the higher-order terms and neglecting coefficients.

$$𝒪 ( \text{?} + ( 4 {T}_{{n}_{R}} ( 2 P + 1 ) - 1 ) \cdot \text{?} \cdot {M}^{P} ) > 𝒪 ( {n}_{R} \cdot P \cdot {T}^{P + 1} \cdot {M}^{P} \cdot {n}_{T}^{P - 1} ) , \qquad ( 40 )$$

$$\text{?} \text{indicates text missing or illegible when filed}$$

The practical unfeasibility of ML-based detection of QSM systems is clearly highlighted by equation (40), as it exposes the fact that the number of transmit symbols P is a complexity order exponent of all theoretically scalable quantities n_{T}, T and M. Next, let us show that this challenge cannot be satisfactorily mitigated by the SD approach. To that end, consider again idealistically and for simplicity, that SD can reduce the search radius to a single symbol, such that the factor MP in equation (40) can be neglected. In other words, we find that the order of complexity associated to SD-based QSM receivers can, at best, be reduced to

$$𝒪 ( {n}_{R} \cdot P \cdot {T}^{P + 1} , {n}_{T}^{P - 1} ) \qquad ( 41 )$$

From the latter it can be concluded that, in the context of scalable QSM schemes, the only advantage of SD is to enable scaling of the digital constellation cardinality M, which not only impacts negatively on the corresponding BER, but also is not the most significant factor in increasing the SE of the system, since the total number of bits conveyed by a QSM scheme is B=2·[log₂(_{P}^{Tn}^{_{T}})]+P·log₂ M such that even for mildly large n_{T}, T and P we have 2·[log₂ (_{P}^{Tn}^{_{T}})]>>P·log₂ M. In summary, it can be concluded that sphere detection is not particularly useful as an enabler of spectrally-efficient scalable QSM, from a receiver perspective.

Finally, let us address the computation complexity of the proposed GB-ISTA. For starters, observe from equations (31) through (36) that the GB-ISTA receiver obtains the spatially encoded bits b^{R} and b^{I} not from a search, but directly from the sparse-recovery process, i.e., the value and locations of non-zero elements of u\hat{ }. As a consequence of removing such combinatorial search, the impact of the scalable parameters n_{T}, T and P onto GB-ISTA is significantly smaller, as demonstrated by the following complexity analysis of the steps of method 3.

1) Method 3 takes as input the effective matrix G given in equation (27), whose construction requires evaluating the product of the sparse block-diagonal Matrix Φ_{H} ∈ [symbol] ^{2Tn}^{_{R}}^{×22Tn}^{_{T}}, which contains 2nr non-zero entries per row, against the matrix Ψ_{D}∈ [symbol] ^{2Tn}^{_{T}}^{×22Tn}^{_{T}}, which has T non-zero entries per column, yielding a cost of 2T (2TH_{R}) (2TN_{T})=8T³n_{T}n_{R} flops, since typically we have (in scaled QSM schemes) T<<2n_{T}.

2) Next, the GB-ISTA receiver performs multiple runs of evaluating equation (31), the first step to which is computing û⁽ⁿ⁾+1/αG^{T}(y−Gû⁽ⁿ⁾). The cost of computing a as per line 1 of method 3 are ignored, under the argument that for large systems, the largest eigenvalues G^{T}G converges almost sure to a constant dependent only on the structure and the energy of G.

That operation would cost (2Tn_{T})(2Tn_{R})+(2Tn_{R})+(2Tn_{R})(2Tn_{T})+(2Tn_{R})=ST2n_{T}n_{R30} 4Tn_{R} flops to accomplish, but since the sparsity of u\hat{ }(n) quickly reduces to the actual value 2P, as shown in FIG. 7 (a), the complexity of that step is more precisely estimated at Then, including 8PTn_{R}+4Th_{R}=4Tn_{R} (2P+1) xed-Hard thresholding function Π, and remembering η* iterations are necessary, the total cost associated with each evaluation run of equation (31) can be estimated at flops. η*(4Tn_{R}(2P+1)+2Tn_{T})

3) After convergence of equation (31), the receiver obtains the sparse estimate vector ûₘ^{(n*)}, from which the soft symbol estimate \tilde{S}_{\hat{q}m} is extracted at negligible cost via maximum value search [44], along with the estimate index \hat{q}ₘ given by the position of \tilde{s}_{\hat{q}m} in ûₘ^{(n*)}, as expressed in equation (32). With these quantities at hand, up to VM flops are consumed to obtain the hard symbol estimate \tilde{s}_{\hat{q}m} as per equation (33).

4) Considering that the cost of the element, interference and column removals expressed by equations (37) through (39) are negligible, the next significant cost of the receiver is the validation of acquired indices. In particular, after at least P runs, when a sufficient number of position indices \hat{q}ₘ have been detected to construct any or both of the index subsequences \hat{q}ₘ^{R} and/or \hat{q}ₘ^{I}, and map them to corresponding estimate index vectors \hat{k}^{R} and/or \hat{k}^{I} as per equation (36), said estimates need be validated against the optimal set of index vectors K. Assuming the cost of such operation is of order O(1), this step contributes to the total complexity of the GB-ISTA detector with an additional cost of P flops.

5) Lastly, as described in line 11 of Algorithm 3, the GB-ISTA outputs both the pair of estimate index vectors \hat{k}^{R} and \hat{k}^{I} as well as the digitally modulated symbol vector estimate ŝ∈ [symbol] ^{P}, which requires the intercalation of the real and imaginary parts, at estimated cost of P flops.

From the above, the total complexity order of the GB-ISTA can be estimated at

$$𝒪 ( {\overbrace{8 {T}^{3} {n}_{T} {n}_{R}}}^{construction of G} + \text{?} ( {\overbrace{{n}^{*} ( 4 {Tn}_{R} ( 2 P + 1 ) + 2 {Tn}_{T} )}}^{evaluation of eq . ( 31 )} + \text{?} ) + \text{?} ) . \qquad ( 42 )$$

$$\text{?} \text{indicates text missing or illegible when filed}$$

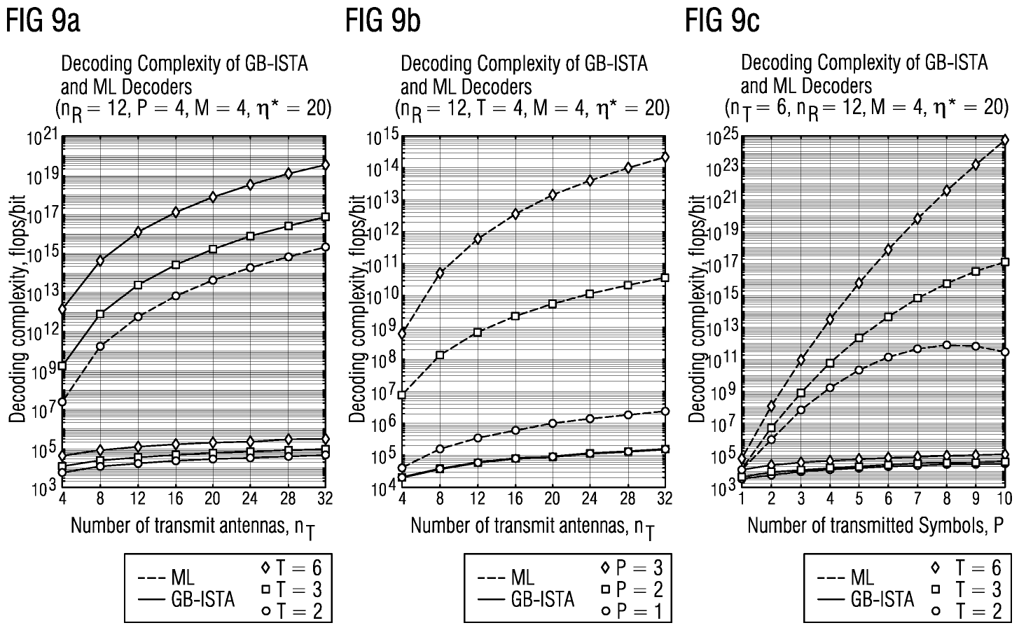

The per-bit complexity orders of the ML and the proposed GB-ISTA decoders, obtained by dividing the expressions in equations (40) and (42) by the number of bits detected per transmission B=2[log₂ (_{P}^{Tn}^{_{T}})]+Plog₂ M. are compared in FIG. 9 for various settings in terms of the scalable parameters n_{T}, T and P

FIG. 9 shows the Effect of scalable parameters on the complexity of QSM receivers.

FIG. 9 (a) shows the Fixed P, various T, as a function of n_{T}
FIG. 9 (b) shows the Fixed T, various P, as a function of nr
FIG. 9 (c) shows the Fixed n_{T}, various T, as a function of P.

### B. BER Performance of the Proposed OS-QSM Scheme

Empowered by the significant reduction in complexity obtained by GB-ISTA over ML detection, as shown above, we proceed to assess the BER performance of the proposed OS-QSM scheme, decoded via the GB-ISTA. In general, our simulated experiments aim to further demonstrate that the proposed OS-QSM are feasible with relatively large numbers of transmit antennas, and can achieve very low BER at very low Et/No with rather high spectral efficiencies, whilst using relatively few spatial-temporal resources per transmission.

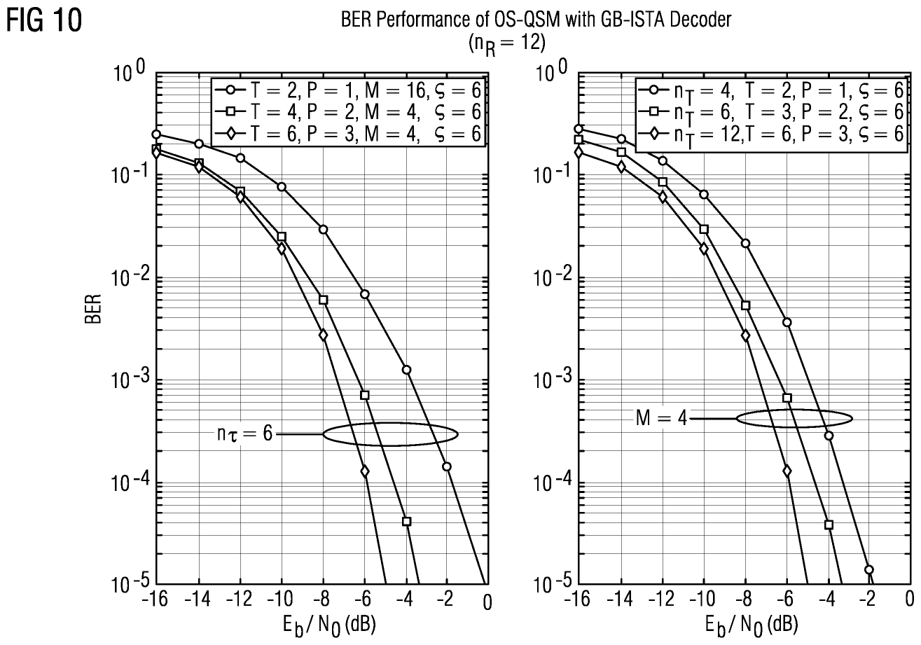

FIG. 10: is the Effect of scalability on BER performance of GB-ISTA-detected OS-QSM schemes with fixed SE.

To that end, our first set of results, shown in FIG. 10, compares the BER performances of the proposed method for various values of n_{T}, T and P, with the ratio P/T kept constant and M adjusted such that all curves corresponds to systems with the same spectral efficiency. We remark that the curves for T=2 can be considered as a reference corresponding to the SotA EDA-QSM scheme, although the results shown actually incorporate improvements due to the enhancements described in Subsection III-B, namely, the utilization of: a) optimal Golden codes, as opposed to the block-by-block sphere-decodable FDFR-STBC of; and b) the optimal construction of index vectors set K, given in method 1.

Two important facts can be learned from the results of FIG. 10. The first is that significant improvement in BER achieved by scaling occurs in spite of the fact that the number of receive antennas is rather large (n_{R}=12). This indicates that the gains are not only due to an increase in diversity (since receive diversity is already large), but also due to the coding gain reaped from the utilization of optimal FDFR-STBCs employed in the OS-QSM design. And the second is that results shown are actually simulated, down to rather low BERs, using a usual computer (i.e. no particularly powerful machine was required), and for settings which are virtually impossible to simulate with ML- or SD-based receivers. The latter point is strengthened by the results of the right side of FIG. 10, which includes a curve for a system with n_{T}=12, which serves to further highlight the true feasibility of the proposed GB-ISTA receiver.

One criticism that could be raised about the results of FIG. 10 is, however, that values of P adopted thereby are not the optimal ones for the corresponding T and n_{T}, as per equation (14). We once again clarify that the parameterization used in FIG. 10 is such that all systems have the same SE, so as to allow their direct comparison under equivalent conditions, which is, incidentally also the reason why all curves are plotted against E_{b}/N₀ as opposed to SNR.

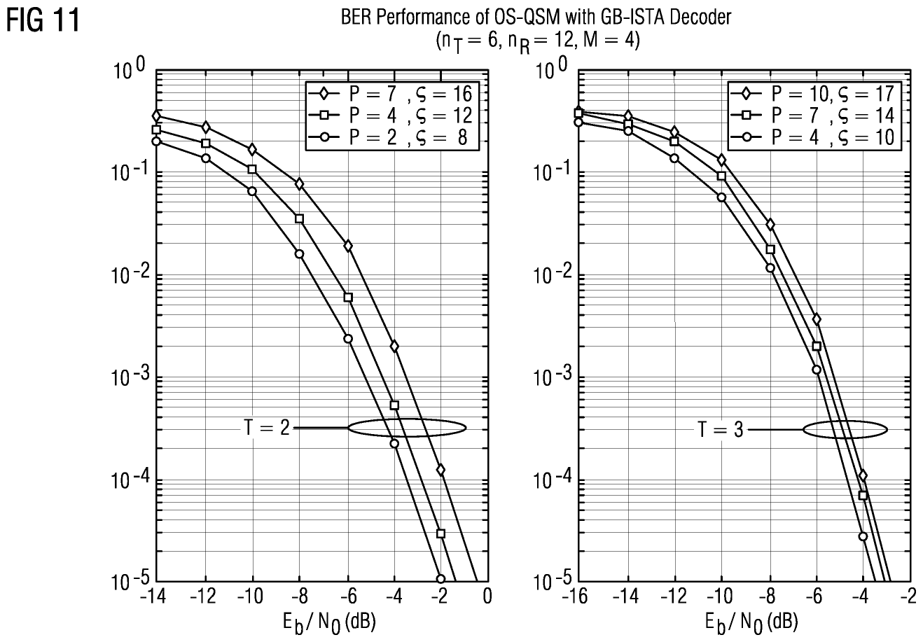

FIG. 11 illustrates the Effect of scaling P on BER performance of GB-ISTA-detected OS-QSM schemes.

In any case, in order to dispel any doubts about the ability of the proposed OS-QSM design and of the corresponding GB-ISTA receiver to actually achieve feasible and optimized spectral efficient combined with low BERs, shown in FIG. 11 additional results obtained by varying P up to the optimal value given by equation (14). We remark that, due to the floor operation in the expression of the achievable SE given by equation 8, values of P adjacent to that given by equation (14)—i.e., P* —are also optimum, as they result in exactly the same SE. For instance, with n_{T}=6, T=2 and M=4, as is the case of FIG. 10, equation (14) yields P*=8, but the values P={7, 8, 9} all result in ζ=16 in equation (8). Similarly, P={10, 11, 12, 13} all yield the largest SE of ζ=17 with n_{T}=6, T=3 and M=4 as is the case of FIG. 11.

With these remarks made, turning to the results obtained in FIG. 11, it can be seen that only a very mild degradation of BER is observed when up-scaling P, which is in fact smaller in for larger T as shown in FIG. 11, which is a small and fair price to pay for almost doubling spectral efficiency of the system. We clarify that the slight BER degradation observed when up-scaling the ratio P/T towards SE optimality is a consequent of the corresponding reduction of sparsity in the vectorized received signal, which tends to be less critical in systems with higher diversity and coding gains, as a result of up-scaling n_{T}, T or both. That trend is in fact observable in FIG. 11, as the gap between BER curves narrows as T=2 is increased to T=3.

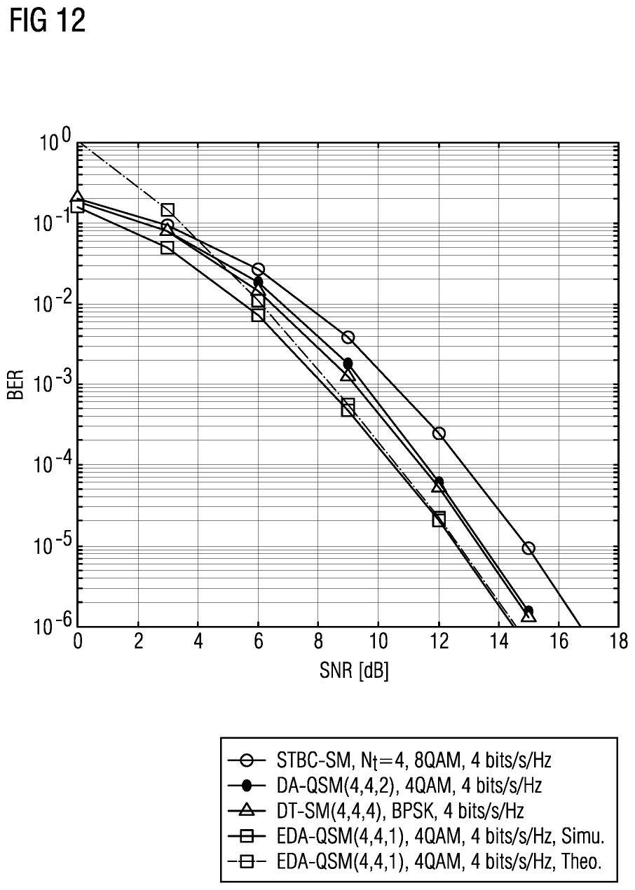

FIG. 12 is a Comparisons of previous spatial modulation schemes

Furthermore, the proposed decoder also does not require design restrictions such as block-diagonality or orthogonality in the transmission scheme, only the sparsity which is inherent with spatial modulation schemes, therefore providing larger freedom in transmitter development as well. In other words, the proposed decoder is capable of coping with many different encoding structures (flexibility).

The decoder can be used in any MIMO system where the number of antennas is expected to be large, such that ML approaches are infeasible. The scheme can be used to increase efficiency in cellular networks and V2X communications (eMBB).

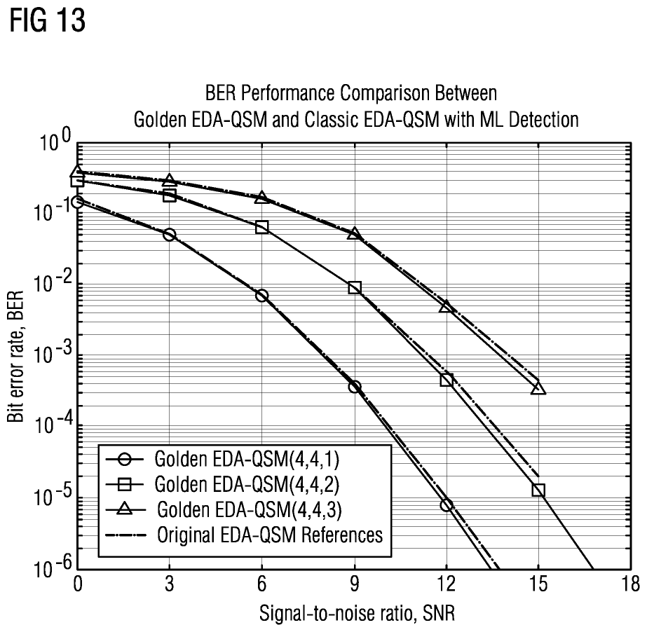

FIG. 13 shows is comparison of Golden EDA-QSM and Original EDA-QSM with ML Decoding and illustrates a comparison of the Golden EDA-QSM vs. Original EDA-QSM

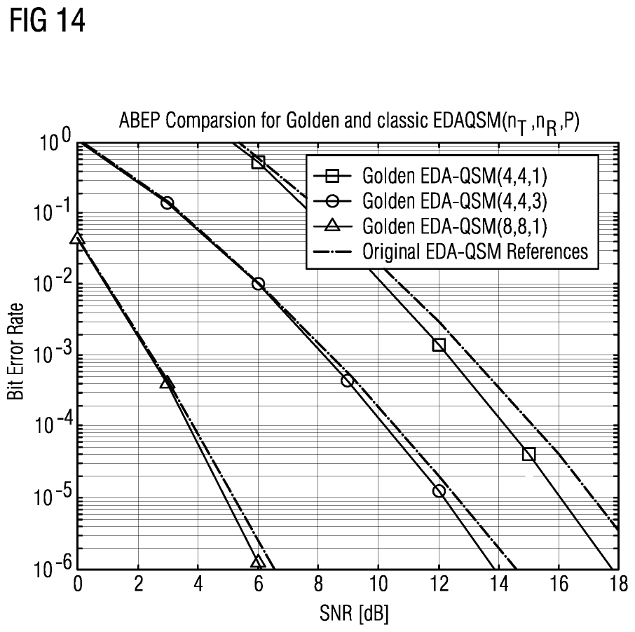

FIG. 14 shows shows is comparison of Golden EDA-QSM vs Original EDA-QSM with Theoretical ABEP

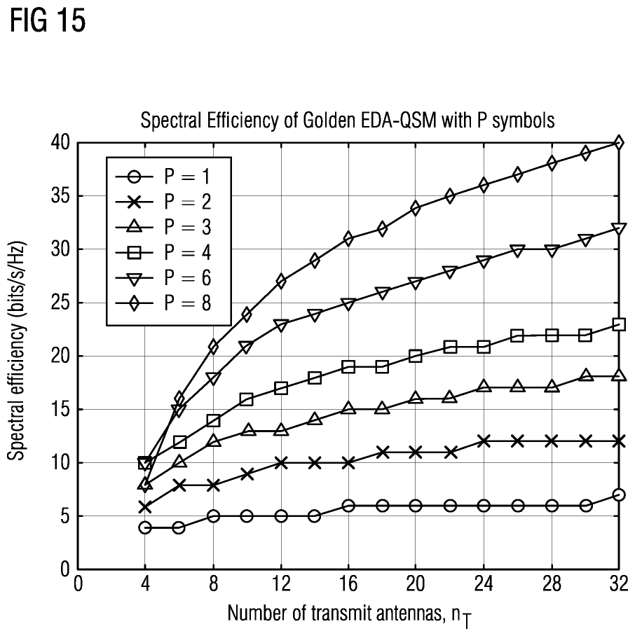

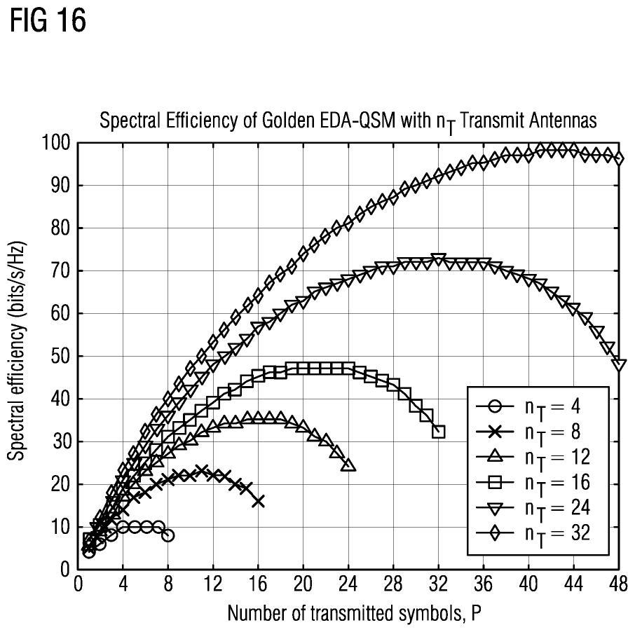

FIG. 15 shows is comparison of the Effect of n_{T} on spectral efficiency of the EDA-QSM

FIG. 16 shows the effect of n_{T} of P on spectral efficiency of the EDA-QSM

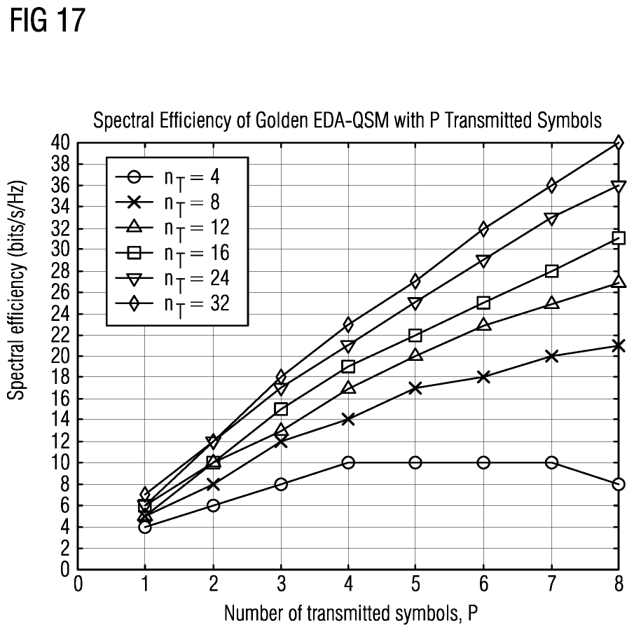

FIG. 17 shows the effect on spectral efficiency of the EDA-QSM, for GISTA feasible regions

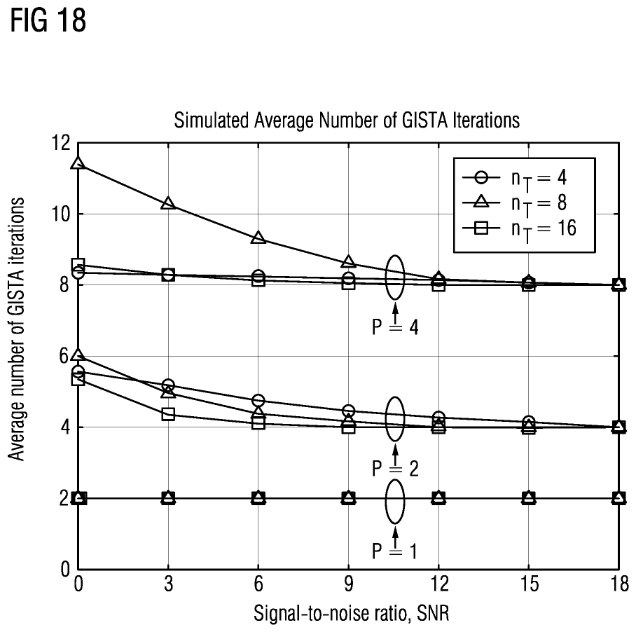

FIG. 18 shows the average number of GISTA iterations with GISTA Decoding

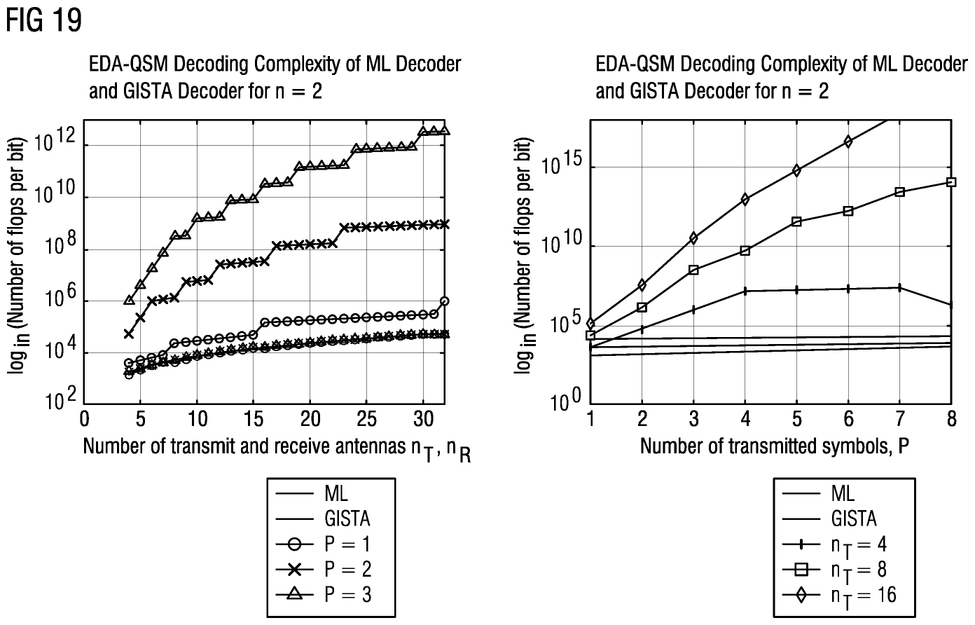

FIG. 19 shows the Illustrations of decoding complexities between the ML and GISTA decoders

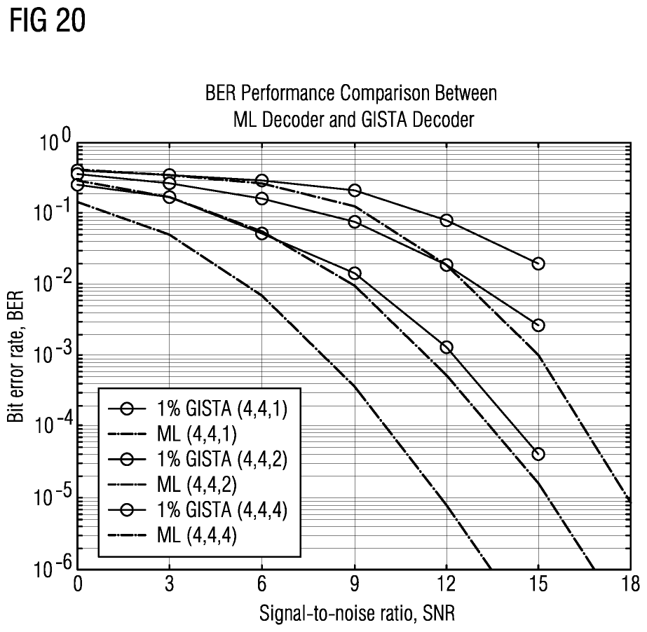

FIG. 20 shows the performance comparison between GISTA and Full-ML Decoders (n_{T} 4)

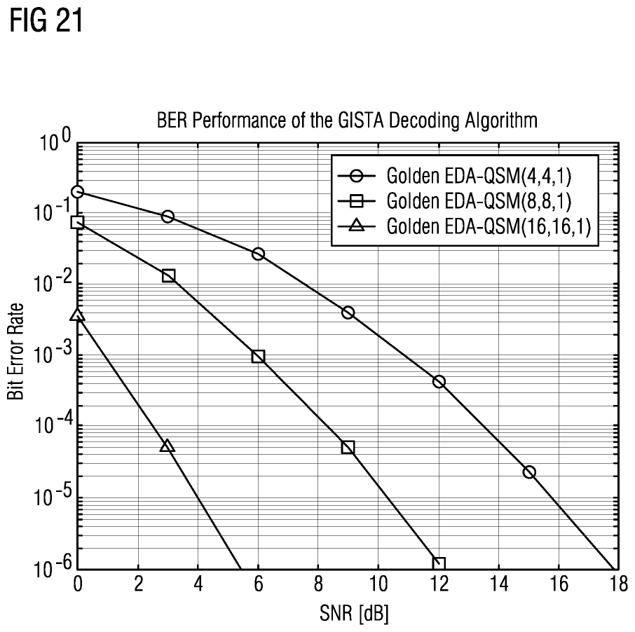

FIG. 21 shows the performance comparison of GISTA Decoding

In this application it is a new transmitter and receiver designs for QSM schemes, focusing on their scalability in terms of the number of transmit antennas n_{T}, number of transmit instances T and number of encoded M-ary symbols P, as well as on their performance optimization in terms of SE, diversity and coding gains proposed. The contributions are motivated by the demonstrated fact that, in order for SE optimality to be achieved, QSM schemes must scale n_{T}, T and P, which is not possible with SotA methods. At the transmitter, the newly proposed OS-QSM scheme differs from SotA alternatives in that its dispersion matrices are designed based on the FDFR STBCs, and in that dispersion matrix index selection is performed via a new greedy algorithm given, which ensures that all spatial-temporal resources of the transmitter are utilized evenly over multiple transmissions. In turn, at the receiver, the proposed art contributes with a new ISTA-based receiver, which thanks to its reliance on the sparse structure of QSM signaling, eliminates the combinatorial nature of existing ML- or SD-based approaches, further enabling the scaling of the system from a feasibility perspective. In fact, a complexity analysis is offered, which shows that the proposed GB-ISTA receiver enjoys a complexity order that is cubic on T, quadratic on P, and only linear on nT, in contrast to the ML and SD detectors which have geometric complexities on T and nT, with P as exponent, rendering them unfeasible in the scaled scenario. Simulation results for set-ups of scales never before shown in related literature, corroborate both the high performance and feasibility of the proposed OS-QSM scheme and GB-ISTA receiver.

1. A computer-implemented optimal and scalable quadrature space-time modulation (OS-QSM) method for configuring a plurality of transmit antennas, the method comprising:
configuring the plurality of transmit antennas to each represent an in-phase spatial constellation symbol within an in-phase spatial constellation, and a quadrature spatial constellation symbol within a quadrature spatial constellation,
mapping source data to the in-phase spatial constellation symbols and the quadrature spatial constellation symbols represented by the plurality of transmit antennas,
wherein the method is applying an optimal and scalable quadrature spatial modulation scheme (OS-QSM) resulting in a maximum possible coding gain in the resultant quadrature spatial modulation.

2. The method of claim 1, wherein a modification to the iterative shrinkage-thresholding algorithm (ISTA) via boxing, range limiting, and hard-thresholding is performed.

3. The method of claim 1, further comprising: proceeding the iterative shrinkage-thresholding algorithm via boxing-hard (ISTA), a greedy selection of the positions of the antennas index and the symbol estimates, and their independent decoding of the corresponding antenna modulated and symbol modulated bits.

4. The method of claim 3, wherein process working parallel to the greedy detections, to ensure valid estimates of the index vectors from the given finite set of index vectors are produced as an output and to apply interference cancellation with the confirmed values,
while keeping track of which indices have been retrieved from the greedy selections, before every iteration check whether from the currently decoded indices, a final confirmation can be calculated,
if it cannot be made, remove the interference by the previous greedy selection and make the next iteration.

5. The method of claim 1, further comprising: generalization of Golden code and in combination with spatial modulation an operating calculation with a highly sparse received signal is done, without causing large multi-user interference for the overlapping of multiple users.

6. The method of claim 5, further comprising: making the signals per-user more-sparse, again allowing for even more users to be overlapped without increasing effective multi-user interference.

7. A receiver of a communication system having a processor, volatile and/or non-volatile memory, at least one interface adapted to receive a signal in an communication channel, wherein the non-volatile memory stores computer program instructions which, when executed by the microprocessor, configure the receiver to perform operations comprising:
configuring a plurality of transmit antennas to each represent an in-phase spatial constellation symbol within an in-phase spatial constellation, and
a quadrature spatial constellation symbol within a quadrature spatial constellation,
mapping source data to the in-phase spatial constellation symbols and the quadrature spatial constellation symbols represented by the plurality of transmit antennas,
wherein applying an optimal and scalable quadrature spatial modulation scheme (OS-OSM) results in a maximum possible coding gain in the resultant quadrature spatial modulation.

8. (canceled)

9. (canceled)

10. (canceled)

11. (canceled)

12. The receiver of claim 7, wherein a modification to the iterative shrinkage-thresholding algorithm (ISTA) via boxing, range limiting, and hard-thresholding is performed.

13. The receiver of claim 7, further comprising: proceeding the iterative shrinkage-thresholding algorithm via boxing-hard (ISTA), a greedy selection of the positions of the antennas index and the symbol estimates, and their independent decoding of the corresponding antenna modulated and symbol modulated bits.

14. The receiver of claim 7, wherein process working parallel to the greedy detections, to ensure valid estimates of the index vectors from the given finite set of index vectors are produced as an output and to apply interference cancellation with the confirmed values,
while keeping track of which indices have been retrieved from the greedy selections, before every iteration check whether from the currently decoded indices, a final confirmation can be calculated,
if it cannot be made, remove the interference by the previous greedy selection and make the next iteration.

15. The receiver of claim 7, further comprising: generalization of Golden code and in combination with spatial modulation an operating calculation with a highly sparse received signal is done, without causing large multi-user interference for the overlapping of multiple users.

16. The receiver of claim 15, further comprising: making the signals per-user more-sparse, again allowing for even more users to be overlapped without increasing effective multi-user interference.
